(19) United States
(12) Patent Application Publication
(10) Pub. No.: US 2025/0327911 A1
(43) Pub. Date: Oct. 23, 2025

(54) IMAGING SYSTEM WITH INCREASED EFFICIENCY

(71) Applicant: SiLC Technologies, Inc., Monrovia, CA (US)

(72) Inventors: Mehdi Asghari, La Canada Flintridge, CA (US); Nirmal Chindhu Warke, Saratoga, CA (US)

(21) Appl. No.: 18/644,030

(22) Filed: Apr. 23, 2024

(51) Int. Cl. G01S 7/4911; G01S 7/481

(52) U.S. Cl. CPC G01S 7/4911; G01S 7/4815

(57) ABSTRACT

The LIDAR system has a signal selector configured to receive multiple outgoing LIDAR signals that each carries a different wavelength channel. The LIDAR system includes a selector controller configured to operate the signal selector such that the signal selector serially outputs multiple different selections of the outgoing LIDAR signals. Each of the selections of the system output signals includes multiple different outgoing LIDAR signals that are concurrently output by the signal selector. The LIDAR system is also configured to concurrently transmit multiple system output signals that each includes light from a different one of the outgoing LIDAR signals that have been output from the signal selector.

### FIELD

The invention relates to optical devices. In particular, the invention relates to LIDAR systems.

### BACKGROUND

The performance demands placed on LIDAR systems is increasing as these systems support an increasing number of applications. LIDAR systems generally generate LIDAR data for a series of sample regions that are each sequentially illuminated by a system output signal. The LIDAR data for a sample region indicates the radial velocity and/or distance between the LIDAR system and one or more objects located in the sample region. The LIDAR system can scan the system output signal to multiple different sample regions. The sample regions can be stitched together to form a field of view for the LIDAR system. As a result, the LIDAR data from the different sample regions provides the LIDAR data for objects within the field of view.

Increasing the rate at which the LIDAR data can be generated for the different sample regions can increase the frequency that the field of view can be scanned and/or can increase the resolution for the field of view. As a result, increasing the LIDAR data generation rate can increase the number of applications to which a LIDAR system can be successfully applied. As a result, there is a need for improved LIDAR systems.

### SUMMARY

The LIDAR system has a signal selector configured to receive multiple outgoing LIDAR signals that each carries a different wavelength channel. The LIDAR system includes a selector controller configured to operate the signal selector such that the signal selector serially outputs multiple different selections of the outgoing LIDAR signals. Each of the selections of the system output signals includes multiple different outgoing LIDAR signals that are concurrently output by the signal selector. The LIDAR system is also configured to concurrently transmit multiple system output signals that each includes light from a different one of the outgoing LIDAR signals that have been output from the signal selector.

A LIDAR system outputs a system output signal that includes light from an outgoing LIDAR signal. The LIDAR system receives a system return signal that includes light from the system output signals after the system output signal was reflected by an object located outside of the LIDAR system. The LIDAR system also includes a light signal combiner that combines light from the system return signal with light from a reference signal. The reference signals also include light from the outgoing LIDAR signal. The reference signal and the outgoing LIDAR signal have a frequency versus time pattern that repeats in cycles where each of the cycles includes a chirp period where the frequency of the outgoing LIDAR signal is chirped at a constant rate. The LIDAR system stops outputting the system output signal while the light in the system output signal from the outgoing LIDAR signal is part way through the chirp period.

A LIDAR system has a signal selector that receives an outgoing LIDAR signal having a frequency versus time pattern that repeats in cycles that each includes a chirp period where the frequency of the outgoing LIDAR signal is chirped at a constant rate. The chirp period includes a reference window in series with a transmission window. The portion of the outgoing LIDAR signal during the transmission window of the chirp period is a chirp segment of the outgoing LIDAR signal. The portion of the outgoing LIDAR signal during the reference window of the chirp period is a reference segment of the outgoing LIDAR signal. The LIDAR system also includes a selector controller configured to operate the signal selector such that the signal selector outputs the portion of the outgoing LIDAR signal that includes light from the transmission segment of the outgoing LIDAR signal but such that the signal selector does not output the portion of the outgoing LIDAR signal that includes light from the reference segment of the outgoing LIDAR signal. The LIDAR system is configured to output a system output signal that includes light from the portion of the outgoing LIDAR signal output from the signal selector. The LIDAR system is also configured to receive a system return signal that includes light from the system output signal after the system output signal has been reflected by an object located outside of the LIDAR system. The LIDAR system includes a light combiner that receive the light from a reference signal and light from the system return signal. The reference signal received by the light combiner includes light from the transmission segment of the outgoing LIDAR signal and also includes light from the reference segment of the outgoing LIDAR signal. The light combiner is configured to combine light from the system return signal with light from reference signal so as to generate a composite signal.

### BRIEF DESCRIPTION OF THE FIGURES

FIG. 1 is a topview of a schematic of a LIDAR chip.

FIG. 2 is a topview of a LIDAR adapter that is suitable for use with the LIDAR chip of FIG. 1.

FIG. 3 is a topview of a LIDAR system that includes the LIDAR chip and electronics of FIG. 1 and the LIDAR adapter of FIG. 2.

FIG. 4A is a schematic of an example of a suitable composite signal generator.

FIG. 4B is a schematic of an example of electronics configured to generate LIDAR data from the output of the composite signal generator shown in FIG. 4A.

FIG. 4C is a graph that illustrates an example of the frequency versus time pattern for outgoing LIDAR signals.

FIG. 4D is a graph that illustrates frequency versus time pattern of LIDAR output signals and the resulting system output signals that can result from outgoing LIDAR signals having the frequency versus time patterns of FIG. 4C.

FIG. 4E is a graph that shows measurement windows added to a portion of the frequency versus time patterns shown in FIG. 4D.

FIG. 4F is a graph that illustrates a possible relationship between sample regions and the frequency versus time patterns of FIG. 4D.

FIG. 5 is a schematic of an example of a light source.

FIG. 6 is a cross section of a waveguide suitable for use as all or a portion of the waveguides on a LIDAR chip.

FIG. 7A is schematic of an example of a suitable signal selector.

FIG. 7B is schematic of an example of a suitable signal selector.

FIG. 8A is a topview of a portion of a LIDAR chip that includes an interface for optically coupling the LIDAR chip with a signal selector.

FIG. 8B is a perspective view of a portion of the LIDAR chip shown in FIG. 8A.

FIG. 8C is a perspective view of an amplifier chip suitable for use with the portion of the LIDAR chip shown in FIG. 8A and FIG. 8B.

FIG. 8D and FIG. 8E illustrate a LIDAR system that includes the LIDAR chip of FIG. 8A and FIG. 8B interfaced with the signal selector of FIG. 8C. FIG. 7D is a topview of the LIDAR system.

FIG. 8E is a cross section of the system shown in FIG. 8D taken along a line extending between the brackets labeled E in FIG. 8D.

### DESCRIPTION

The LIDAR system transmits one or more system output signals that are each associated with a different wavelength channel. The LIDAR system can switch between transmitting multiple different selections of multiple system output signals. In some instances, each selection of system output signals includes multiple different system output signals that are concurrently transmitted from the LIDAR system. The system output signals in the same selection can be directed toward the same sample region within the LIDAR system's field of view.

The system output signals within the same selection can be reflected by an object located within the sample region to which the selection of system output signals is directed. Light from each of the reflected systems output signals in the selection can return to the LIDAR system in a system return signal. The LIDAR system includes multiple light signal combiners that each receives a different one of the system return signals. Each of the light signal combiners combines light from each of the system return signals with a reference signal so as to generate a composite signal beating at a beat frequency. Each of the light signal combiners is associated with the same wavelength channel as the system return signal received by the light signal combiner. As a result, each of the composite signals is also associated with one of the wavelength channels. The beat frequencies of composite signal associated with different wavelength channels are used in combination to calculate LIDAR data for the sample region. Generating the LIDAR data for a single sample region from multiple system output signals that are concurrently transmitted increases the rate of LIDAR data generation.

The LIDAR system can alternate between transmitting two or more different selections of the system output signals. For instance, the LIDAR system can serially alternate between transmitting a first selection of the system output signals and a second selection of the system output signals. The LIDAR system is configured such that transmission of a selection of system output signals stops as a result of switching to the transmission of a new selection of the system output signals. The LIDAR system can be configured such that the light signal combiners each continually receives the associated reference signal. As a result, after the LIDAR system stops transmitting a system output signal (the stopped system output signal), the light signal combiner associated with the stopped system output signal continues to receive the reference signal. Additionally, the LIDAR system is configured such that after the LIDAR system stops transmitting the stopped system output signal, the system return signal that includes light from the stopped system output signal can return to the LIDAR system and be received by the associated light signal combiner. As a result, after the LIDAR system stops transmitting a system output signal, the light signal combiner can continue to generate the composite signal associated with the stopped system output signal. The ability to continue generating a composite signal after transmission of the associated system output signal improves the ability of the LIDAR system to calculate LIDAR data for objects that are long distances from the LIDAR system.

After stopping the transmission of a stopped system output signal, the LIDAR system switches to transmitting another selection of the system output signals. The LIDAR system is configured such that transmitting the next selection of system output signals does not interfere with generating the composite signals that result from the transmission of the prior selection of system output signals. As a result, the next selection of the system output signals is being transmitted toward the next sample region while the composite signal from the previous sample region is still being generated. As a result, the LIDAR system has an increased rate of LIDAR data generation combined with an enhanced performance at longer object distances.

FIG. 1 is a topview of a schematic of a LIDAR chip. In some instances, the LIDAR chip is a semiconductor chip that includes a photonic circuit. The illustrated LIDAR chip includes a light source 10 that outputs multiple different outgoing LIDAR signals. Each of the different outgoing LIDAR signals is associated with a channel index with a value from m=1 to m=M. For instance, FIG. 1 illustrates the light source 10 outputting an outgoing LIDAR signal labeled m=1 and an outgoing LIDAR signal labeled m=2. Light signals processed by the LIDAR system can be associated with the channel index that is also associated with the outgoing LIDAR signal that is the source of the light signal. For instance, FIG. 1 includes a label that identifies a light signals output from the LIDAR system as associated the channel index m=1 because the light signal includes light from the outgoing LIDAR signal labeled m=1. FIG. 1 also labels components that receive and/or process light signals associated with one of the channel indices. For instance, FIG. 1 shows the optical pathways that light signals associated with channel index m=1 travel through the LIDAR system and between the LIDAR system and an object located outside of the LIDAR system. The light signals associated with channel index m=1 and the components that receive and/or process light signals associated with channel index m=1 are labeled m=1. Additionally, light signals associated with channel index m=2 and the components that receive and/or process light signals associated with channel index m=2 are labeled m=2 in FIG. 1. In order to simplify FIG. 1, the optical pathways that light signals associated with channel index m=2 travel between the LIDAR system and an object located outside of the LIDAR system are not shown.

In some instances, the multiple different outgoing LIDAR signals are concurrently output from the light source 10. For instance, during operation of some embodiments of the LIDAR system, the light source 10 concurrently outputs the outgoing LIDAR signals associated with channel index m=1 through m=4.

The LIDAR chip also includes utility waveguides 12 that each receives a different one of the outgoing LIDAR signals from the light source 10. Each of the utility waveguide 12 terminates at a port 14 through which light signals can exit and/or enter the utility waveguide 12. Each of the utility waveguides 12 carries the one of outgoing LIDAR signals to the port 14 at which the utility waveguides 12 terminates and the outgoing LIDAR signal exits the utility waveguides 12 through the port 14. An example of a port 14 is a facet of a utility waveguide 12.

The LIDAR chip includes a signal selector 16 that receives the outgoing LIDAR signals from the ports. The signal selector 16 is configured to select which portion of each outgoing LIDAR signal is output from the signal selector and which portion of each outgoing LIDAR signal is not output from the signal selector. As a result, the signal selector 16 can be operated so as to select which of the outgoing LIDAR signals exits from the LIDAR chip and serves as a LIDAR output signal. For instance, the signal selector 16 can be operated so as to select whether the outgoing LIDAR signal associated with channel m=1 and m=3 concurrently exit from the LIDAR chip and serves as the LIDAR output signals or whether the outgoing LIDAR signal associated with channel m=2 and m=4 concurrently exit from the LIDAR chip and serves as the LIDAR output signals. The signal selector 16 can be configured such that the one or more unselected outgoing LIDAR signals either do not exit from the LIDAR chip or exit from the LIDAR chip as inactive LIDAR output signals. The optical output power of the inactive LIDAR output signal can be negligible relative to the optical output power of selected LIDAR output signals. As a result, the LIDAR system does not calculate LIDAR data from light included in any inactive LIDAR output signals output from the LIDAR system. Accordingly, any inactive LIDAR output signals are disregarded and considered to have not been output from the signal selector and are processed as if they have not been output from the signal selector.

FIG. 1 illustrates the signal selector 16 having multiple selector waveguides 20 that each receives a different one of the outgoing LIDAR signals. Each of the selector waveguides 20 terminates at a facet that serves as a port 18. Each of the selector waveguides carries one of the outgoing LIDAR signals to a port 18 through which the outgoing LIDAR signals exits the signal selector 16. The signal selector 16 can include optical components in addition to the selector waveguides 20.

The LIDAR chip includes multiple second utility waveguides 22. Each of the second utility waveguides 22 receives one of the one of the outgoing LIDAR signals from one of the selector waveguides 20. Additionally, the LIDAR chip includes a multiplexer 24 that receives the outgoing LIDAR signals from the second utility waveguides 22. Accordingly, each second utility waveguide 22 carries one of the outgoing LIDAR signals to a multiplexer 24. The multiplexer 24 is configured to direct the outgoing LIDAR signals to a common waveguide such as an output waveguide 25. Since the signal selector 16 can concurrently output outgoing LIDAR signals associated with different alternate waveguide indices, the multiplexer 24 can combine different outgoing LIDAR signals on the output waveguide 25. Accordingly, the output waveguide 25 can carry one or more outgoing LIDAR signals. When the output waveguide 25 carries multiple outgoing LIDAR signals, each of the outgoing LIDAR signals can be associated with a different alternate waveguide index. Suitable multiplexers 24 include, but are not limited to, Arrayed Waveguide Gratings (AWGs), echelle gratings, and multiple Mach-Zehnder Interferometers (MZIs).

The LIDAR system includes one or more ports through which outgoing LIDAR signals can exit the LIDAR chip. For instance, a facet of the output waveguide 25 can serve as a port 18 through which the outgoing LIDAR signal can exit the LIDAR chip and serve as a LIDAR output signal. A facet that serves as a port can be positioned at an edge of the chip so the outgoing LIDAR signal traveling through the port exits the chip and serves as the LIDAR output signal.

The LIDAR chip can be the LIDAR system or can be included in a LIDAR system. The LIDAR system outputs one or more system output signals that are each associated with one of the alternate waveguide indices. Each of the system output signals includes light from the LIDAR output signal associated with the same alternate waveguide index. For instance, the system output signal associated with channel index m=2 includes light from the LIDAR output signal associated with channel index m=2. Light from each of the system output signal travels away from the LIDAR system and may be reflected by objects in the path of the system output signal. When a system output signal is reflected, at least a portion of the reflected light can return to the LIDAR system in a system return signal. At least a portion of the system return signal is received by the LIDAR chip as a LIDAR input signal that includes light from the system return signal. Each of the LIDAR input signals is associated with one of the alternate waveguide indices. Each of the LIDAR input signals includes light from the system output signal associated with the same alternate waveguide index. For instance, the LIDAR input signals associated with channel index m=2 includes light from the system output signal associated with channel index m=2. In some instances, the system return signal can serve as the LIDAR input signal. For instance, when the LIDAR chip serves as the LIDAR system, the system return signal can serve as the LIDAR input signal.

The LIDAR chip includes a LIDAR input waveguide 26, a demultiplexer 28, and channel waveguides 30 that are each associated with one of the alternate waveguide indices. The LIDAR input waveguide 26 is configured to receive the LIDAR input signals and carry the LIDAR input signals to the demultiplexer 28. The demultiplexer 28 directs the LIDAR input signals to the channel waveguides 30 such that each LIDAR input signal is received by the channel waveguide that is associated with the same channel index as the LIDAR input signal. Accordingly, each of the channel waveguides 30 and the LIDAR input signal received by the channel waveguide 30 are associated with the same channel index. As an example, the channel waveguide 30 associated with channel index m=1 can receive the LIDAR input signal associated with channel index m=1 and the channel waveguide 30 associated with channel index m=2 can receive the LIDAR input signal associated with channel index m=2. Suitable demulitplexers 28 include, but are not limited to, Arrayed Waveguide Gratings (AWGs), echelle gratings, and multiple Mach-Zehnder Interferometers (MZIs).

The portion of the LIDAR input signal that enters a channel waveguide 30 can serve as a comparative signal that includes or consists of light from the LIDAR input signal. Each of the channel waveguides 30 is configured to carry the comparative signal received by that channel waveguide 30 to one of multiple different composite signal generators 32. Each of the composite signal generators 32 is associated with one of channel indices. For instance, each of the composite signal generators 32 and the comparative signals received by the composite signal generator 32 are associated with the same channel index. As an example, the comparative signal associated with channel index m=1 is received at the composite signal generator 32 associated with channel index m=1.

A splitter 34 is positioned along each of the utility waveguides. Each of the splitters 34 is configured to receive an outgoing LIDAR signal from a first portion of the utility waveguide 12. The outgoing LIDAR signal that a splitter 34 receives from the first portion of the utility waveguide 12 can be considered a preliminary outgoing LIDAR signal. Each of the splitters 34 is configured to output a first portion of the outgoing LIDAR on a second portion of the utility waveguide 12. Accordingly, the first portion of the outgoing LIDAR can continue to serve as the outgoing LIDAR signal. Each splitter 34 is also configured to output a second portion of the outgoing LIDAR signal on a reference waveguide 36. Suitable splitters 34 include, but are not limited to, directional couplers, optical couplers, y-junctions, tapered couplers, and Multi-Mode Interference (MMI) devices. When the splitter 34 is a directional coupler the splitter 34 moves a portion of the outgoing LIDAR signal from the utility waveguide 12 onto a reference waveguide 36 as a reference signal. Each reference waveguide 36 carries the reference signal to one of the composite signal generators 32 for further processing. The reference waveguides are arranged such that the composite signal generator 32 receives a comparative signal and a reference signal associated with the same channel index. Although FIG. 1 illustrates directional couplers operating as the splitters 34, other signal tapping components can be used as the splitter 34. Suitable splitters 34 include, but are not limited to, directional couplers, optical couplers, y-junctions, tapered couplers, and Multi-Mode Interference (MMI) devices.

The LIDAR system can include electronics 56. The electronics 56 can include a light source controller 62. The light source controller 62 can operate the light source 10 such that each of the outgoing LIDAR signals, and accordingly, the resulting system output signals, has a particular frequency versus time pattern. For instance, the light source controller 62 can operate the light source such that each of the outgoing LIDAR signals, and accordingly the resulting system output signals, has different chirp rates during different data periods.

The LIDAR chip can optionally include one or more control branches 64 for controlling the operation of the light source 10. For instance, the one or more control branches 64 can provide a feedback loop that the light source controller 62 uses in operating the light source such that the outgoing LIDAR signals have the desired frequency versus time pattern. In FIG. 1, a control branch 64 includes multiple splitters 66 that are each positioned along one of the reference waveguides 36. Each of the splitters 66 is configured to receive a reference signal from a first portion of the reference waveguide 36 and to output a first portion of the reference signal on a second portion of the reference waveguide 36. Accordingly, the first portion of the reference signal continues to serve as the reference signal. Each splitter 66 is also configured to output a second portion of the reference LIDAR signal on a control waveguide 38. Suitable splitters 66 include, but are not limited to, directional couplers, optical couplers, y-junctions, tapered couplers, and Multi-Mode Interference (MMI) devices. When the splitter 66 is a directional coupler the splitter 66 moves the second portion of the reference signal from the reference waveguide 36 onto a control waveguide 68 as a control signal.

An optical attenuator 70 is positioned along each of the control waveguides 68 and each control waveguide 68 carries one of the control signals to a control multiplexer 72. The control multiplexer 72 is configured to direct the control signals to a second control waveguide 73. The optical attenuators 70 can be operated by the light source controller 62. The light source controller 62 can operate the optical attenuators 70 so as to select which of the control signals is received at the control multiplexer 72. Suitable control mulitplexers 72 include, but are not limited to, Arrayed Waveguide Gratings (AWGs), echelle gratings, and multiple Mach-Zehnder Interferometers (MZIs).

Since the control multiplexer 72 directs the control signals to the second control waveguide 73, the light source controller 62 can operate the optical attenuators 70 so as to select which of the control signals is received at second control waveguide 73. The light source controller 62 can operate the optical attenuators 70 such that second control waveguide 73 receives control signals associated with different alternate waveguide indices in series. For instance, the light source controller 62 can operate the optical attenuators 70 such that second control waveguide 73 receives control signals in repeated series where each series includes the control signal associated with m=1, followed by the control signal associated with m=2, followed by the control signal associated with m=3, followed by the control signal associated with m=4.

The second control waveguide 28 carries the control signals to a feedback system 74. The feedback system 74 can include one or more light sensors (not shown) that convert the control signals to electrical signals that are output from the feedback system 74. The light source controller 62 can receive the electrical signals output from the feedback system 74. During operation, the light source controller 62 can adjust the frequency of the outgoing LIDAR signals in response to output from the electrical signals output from the feedback system 74. An example of a suitable construction and operation of feedback system 74 and light source controller 62 is provided in U.S. patent application Ser. No. 16/875,987, filed on 16 May 2020, entitled “Monitoring Signal Chirp in outbound LIDAR signals,” and incorporated herein in its entirety; and also in U.S. patent application Ser. No. 17/244,869, filed on 29 Apr. 2021, entitled “Reducing Size of LIDAR System Control Assemblies,” and incorporated herein in its entirety.

Although FIG. 1 illustrates the splitters 66 positioned along the reference waveguides 36, the splitters 66 can be positioned along the utility waveguides 12.

The electronics 56 can also include a selector controller 76 configured to operate the signal selector 16 so as to select which of the outgoing LIDAR signals exit from the signal selector, which of the LIDAR output signals exit from the LIDAR chip, and/or which of the system output signals exit from the LIDAR system.

In some instances, a LIDAR chip constructed according to FIG. 1 is used in conjunction with a LIDAR adapter. In some instances, the LIDAR adapter can be physically optically positioned between the LIDAR chip and the one or more reflecting objects and/or the field of view in that an optical path that the first LIDAR input signal(s) and/or the LIDAR output signal travels from the LIDAR chip to the field of view passes through the LIDAR adapter. Additionally, the LIDAR adapter can be configured to operate on the LIDAR input signal and the LIDAR output signal such that the LIDAR input signal and the LIDAR output signal travel on different optical pathways between the LIDAR adapter and the LIDAR chip but on the same optical pathway between the LIDAR adapter and a reflecting object in the field of view.

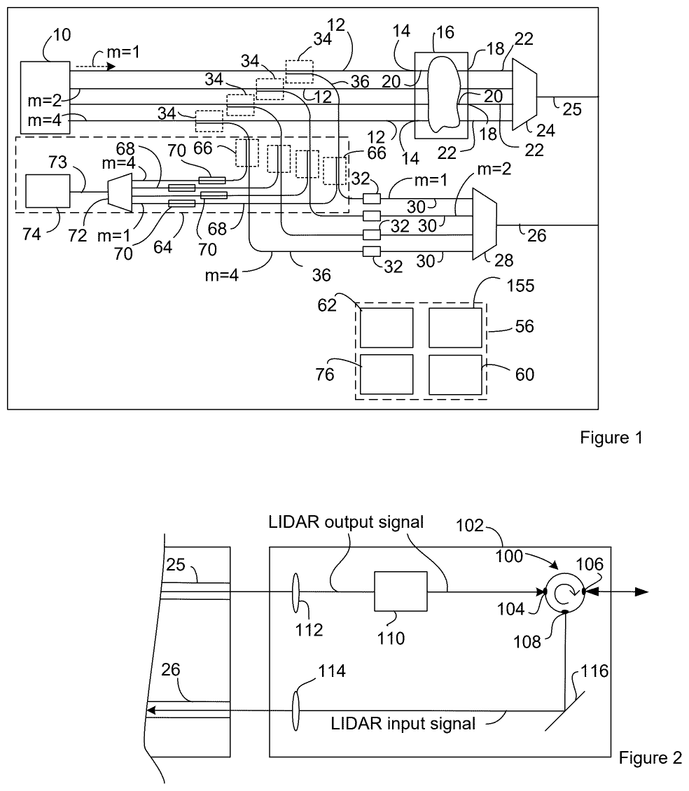

An example of a LIDAR adapter that is suitable for use with the LIDAR chip of FIG. 1 is illustrated in FIG. 2. The LIDAR adapter includes multiple components positioned on a base. For instance, the LIDAR adapter includes a circulator 100 positioned on a base 102. The illustrated optical circulator 100 includes three ports and is configured such that light entering one port exits from the next port. For instance, the illustrated optical circulator includes a first port 104, a second port 106, and a third port 108. The LIDAR output signal enters the first port 104 from the utility waveguide 12 of the LIDAR chip and exits from the second port 106.

The LIDAR adapter can be configured such that the output of the LIDAR output signal from the second port 106 can also serve as the output of the LIDAR output signal from the LIDAR adapter and accordingly from the LIDAR system. As a result, the LIDAR output signal can be output from the LIDAR adapter such that the LIDAR output signal is traveling toward a sample region in the field of view. Accordingly, in some instances, the portion of the LIDAR output signal that has exited from the LIDAR adapter can also be considered the system output signal. As an example, when the exit of the LIDAR output signal from the LIDAR adapter is also an exit of the LIDAR output signal from the LIDAR system, the LIDAR output signal can also be considered a system output signal.

The LIDAR output signal output from the LIDAR adapter includes, consists of, or consists essentially of light from the LIDAR output signal received from the LIDAR chip. Accordingly, the LIDAR output signal output from the LIDAR adapter may be the same or substantially the same as the LIDAR output signal received from the LIDAR chip. However, there may be differences between the LIDAR output signal output from the LIDAR adapter and the LIDAR output signal received from the LIDAR chip. For instance, the LIDAR output signal can experience optical loss as it travels through the LIDAR adapter and/or the LIDAR adapter can optionally include an amplifier configured to amplify the LIDAR output signal as it travels through the LIDAR adapter.

When one or more objects in a sample region reflect a system output signal, at least a portion of the reflected light travels back to the circulator 100 as a system return signal. The system return signal enters the circulator 100 through the second port 106. FIG. 2 illustrates the LIDAR output signal and the system return signal traveling between the LIDAR adapter and the sample region along the same optical path.

The system return signal exits the circulator 100 through the third port 108 and is directed to the comparative waveguide 18 on the LIDAR chip. Accordingly, all or a portion of the system return signal can serve as the first LIDAR input signal and the first LIDAR input signal includes or consists of light from the system return signal. Accordingly, the LIDAR output signal and the first LIDAR input signal travel between the LIDAR adapter and the LIDAR chip along different optical paths.

As is evident from FIG. 2, the LIDAR adapter can include optical components in addition to the circulator 100. For instance, the LIDAR adapter can include components for directing and controlling the optical path of the LIDAR output signal and the system return signal. As an example, the adapter of FIG. 2 includes an optional amplifier 110 positioned so as to receive and amplify the LIDAR output signal before the LIDAR output signal enters the circulator 100. The amplifier 110 can be operated by the electronics 56 allowing the electronics 56 to control the power of the LIDAR output signal. Suitable amplifiers include, but are not limited to, Semiconductor Optical Amplifiers (SOAs), optical fiber-based amplifiers, or optical waveguide based amplifiers. In some instances, the amplifier 110 is an Erbium-doped fiber amplifier (EDFAs) or Erbium-doped waveguide amplifier (EDWAs). Erbium-doped fiber amplifiers (EDFAs) or Erbium-doped waveguide amplifier (EDWAs) can efficiently provide the system output signals with sufficient power levels at distances greater than or equal to 1 km from the preliminary LIDAR system or the secondary LIDAR system. Erbium-doped fiber amplifiers (EDFAs) can provide the system output signals with a power level greater than or equal to 1 W or 3 W at distances greater than or equal to 1 km from the preliminary LIDAR system or the secondary LIDAR system.

FIG. 2 also illustrates the LIDAR adapter including an optional first lens 112 and an optional second lens 114. The first lens 112 can be configured to couple the LIDAR output signal to a desired location. In some instances, the first lens 112 is configured to focus or collimate the LIDAR output signal at a desired location. In one example, the first lens 112 is configured to couple the LIDAR output signal on the first port 104 when the LIDAR adapter does not include an amplifier 110. As another example, when the LIDAR adapter includes an amplifier 110, the first lens 112 can be configured to couple the LIDAR output signal on the entry port to the amplifier 110. The second lens 114 can be configured to couple the LIDAR output signal at a desired location. In some instances, the second lens 114 is configured to focus or collimate the LIDAR output signal at a desired location. For instance, the second lens 114 can be configured to couple the LIDAR output signal on a facet of an input waveguide 26.

The LIDAR adapter can also include one or more direction changing components such as mirrors. FIG. 2 illustrates the LIDAR adapter including a mirror as a direction-changing component 116 that redirects the system return signal from the circulator 100 to the facet 20 of the comparative waveguide 18.

The LIDAR chips include one or more waveguides that constrains the optical path of one or more light signals. While the LIDAR adapter can include waveguides, the optical path that the system return signal and the LIDAR output signal travel between components on the LIDAR adapter and/or between the LIDAR chip and a component on the LIDAR adapter can be free space. For instance, the system return signal and/or the LIDAR output signal can travel through the atmosphere in which the LIDAR chip, the LIDAR adapter, and/or the base 102 is positioned when traveling between the different components on the LIDAR adapter and/or between a component on the LIDAR adapter and the LIDAR chip. As a result, optical components such as lenses and direction changing components can be employed to control the characteristics of the optical path traveled by the system return signal and the LIDAR output signal on, to, and from the LIDAR adapter.

Suitable bases 102 for the LIDAR adapter include, but are not limited to, substrates, platforms, and plates. Suitable substrates include, but are not limited to, glass, silicon, and ceramics. The components can be discrete components that are attached to the substrate. Suitable techniques for attaching discrete components to the base 102 include, but are not limited to, epoxy, solder, and mechanical clamping. In one example, one or more of the components are integrated components and the remaining components are discrete components. In another example, the LIDAR adapter includes one or more integrated amplifiers, and the remaining components are discrete components.

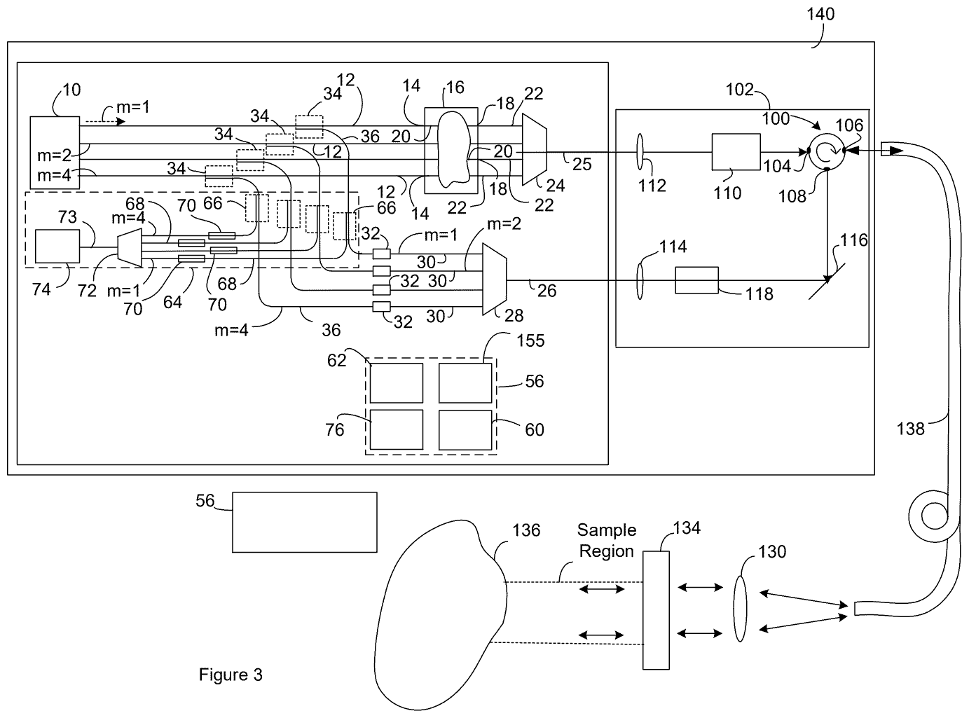

When the LIDAR system includes a LIDAR chip and a LIDAR adapter, the LIDAR chip, electronics, and the LIDAR adapter can be positioned on a common mount. Suitable common mounts include, but are not limited to, glass plates, metal plates, silicon plates and ceramic plates. As an example, FIG. 3 is a topview of a LIDAR system that includes the LIDAR chip and electronics 56 of FIG. 1 and the LIDAR adapter of FIG. 2 on a common mount 128. Although the electronics 56 are illustrated as being located on the common support, all or a portion of the electronics can be located off the common support. When the light source 4 is located off the LIDAR chip, the light source can be located on the common mount 128 or off the common mount 128.

Although FIG. 3 illustrates the electronics 56 as located on the common mount 128, all or a portion of the electronics can be located off the common mount 128. When the light source 10 is located off the LIDAR chip, the light source can be located on the common mount 128 or off of the common mount 128. Suitable approaches for mounting the LIDAR chip, electronics, and/or the LIDAR adapter on the common mount 128 include, but are not limited to, epoxy, solder, and mechanical clamping. Suitable common mounts 128 include, but are not limited to, substrates such as glass plates, metal plates, silicon plates and ceramic plates.

The LIDAR systems of FIG. 3 can include one or more system components that are at least partially located off the common mount 128. Examples of suitable system components include, but are not limited to, optical links, beam shapers, polarization state rotators, beam scanners, optical splitters, optical amplifiers, and optical attenuators. The LIDAR system of FIG. 3 includes one or more beam shapers 130 that receive the LIDAR output signal from the adapter and output a shaped signal. The one or more beam shapers 130 can be configured to provide the shaped signal with the desired shape. For instance, the one or more beam shapers 130 can be configured to output a shaped signal that focused, diverging or collimated. In FIG. 3, the one or more beam shapers 130 is a lens that is configured to output a collimated shaped signal.

The LIDAR systems of FIG. 3 can optionally include one or more beam scanners 134 that receive the shaped signal from the one or more beam shapers 130 and that output the system output signal. The electronics 56 can include a steering controller 60 is configured to operate the one or more beam scanners 134 so as to steer the system output signals to different sample regions within the field of view of the LIDAR system. The sample regions can extend away from the LIDAR system to a maximum operational distance for which the LIDAR system is configured to provide reliable LIDAR data. The sample regions can be stitched together to define the field of view. For instance, the field of view of for the LIDAR system includes or consists of the space occupied by the combination of the sample regions. As a result, the sample regions can serve as three-dimensional pixels. Suitable beam scanners include, but are not limited to, movable mirrors, MEMS mirrors, optical phased arrays (OPAs), optical gratings, actuated optical gratings and actuators that move the LIDAR chip, LIDAR adapter, and/or common mount 128.

System output signals that carry different channels can be concurrently output from the LIDAR system. System output signals concurrently transmitted from the LIDAR system are concurrently directed to the same sample region and the spot sizes of these system output signals can overlap in the same region. In some instances, the spot sizes of system output signals concurrently transmitted from the LIDAR system overlap at the maximum operational distance of the LIDAR system. For instance, at the maximum operational distance of the LIDAR system, each of the system output signals concurrently transmitted from the LIDAR system can have a spot size that overlaps with one or more of the other system output signals concurrently transmitted from the LIDAR system by at least 50%, 90%, or 100% of the spot size of the system output signal. As a result, the system output signals can overlap for the full length of the sample region extending from the LIDAR system to the maximum operational distance of the LIDAR system.

When the system output signal is reflected by an object 136 located outside of the LIDAR system and the LIDAR, at least a portion of the reflected light returns to the LIDAR system as a system return signal. When the LIDAR system includes one or more beam scanners 134, the one or more beam scanners 134 can receive at least a portion of the system return signal from the object 136. The one or more beam shapers 130 receive the system return signal from the one or more beam scanners 134 and output a shaped system return signal that is received by the adapter.

The LIDAR system of FIG. 3 includes an optional optical link 138 that carries optical signals to the one or more system components from the adapter, from the LIDAR chip, and/or from one or more components on the common mount. For instance, the LIDAR system of FIG. 3 includes an optical fiber configured to carry the assembly output signal to the beam shapers 130. The use of the optical link 138 allows the source of the system output signal to be located remote from the LIDAR chip. Although the illustrated optical link 138 is an optical fiber, other optical links 138 can be used. Suitable optical links 138 include, but are not limited to, free space optical links and waveguides. When the LIDAR system excludes an optical link, the one or more beam shapers 130 can receive the assembly output signal directly from the adapter.

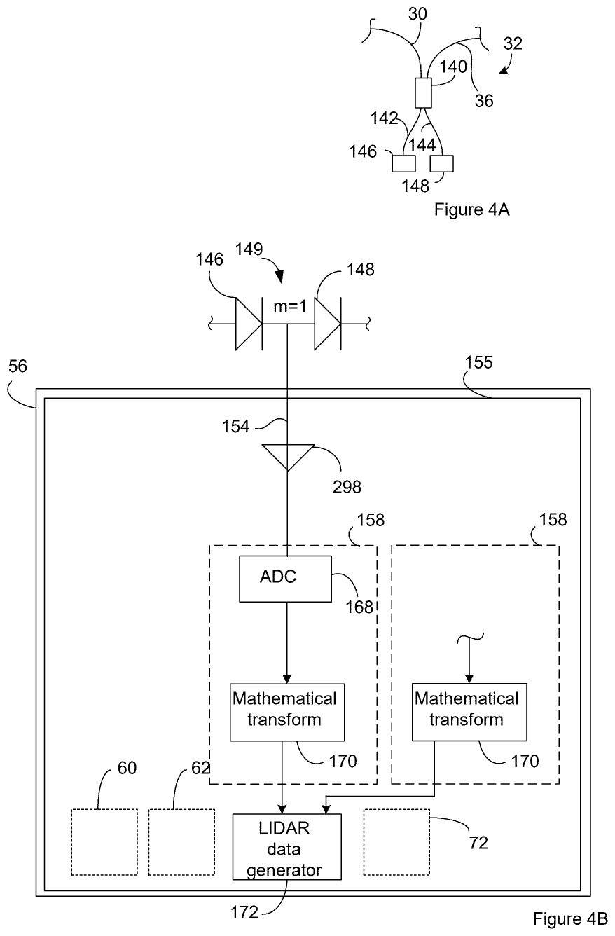

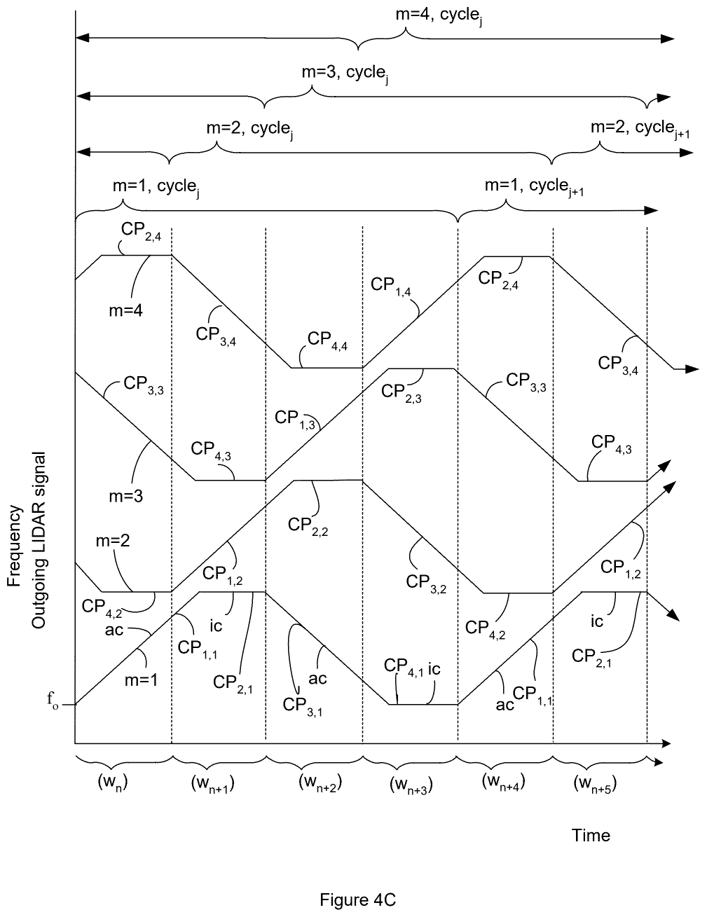

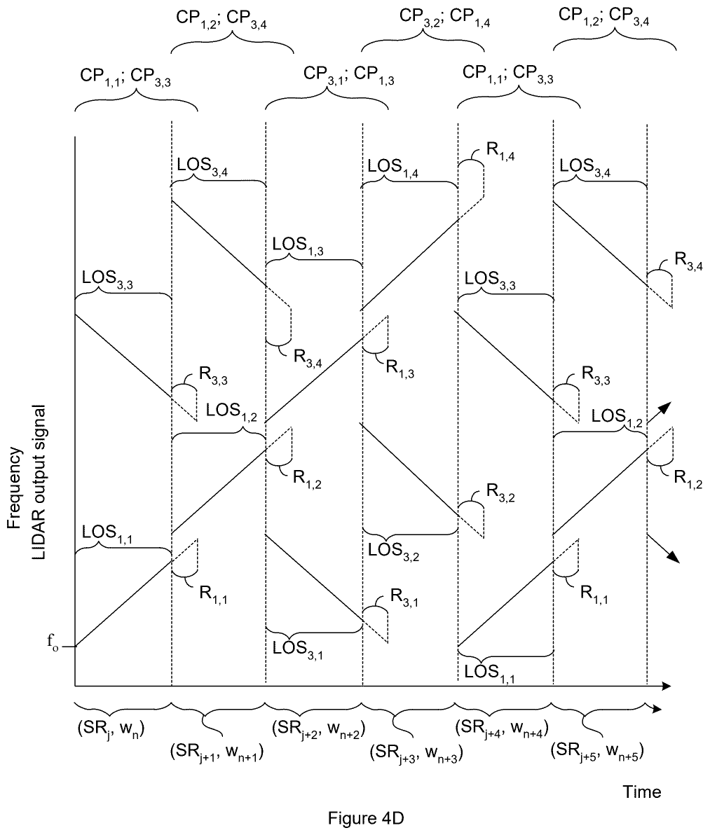

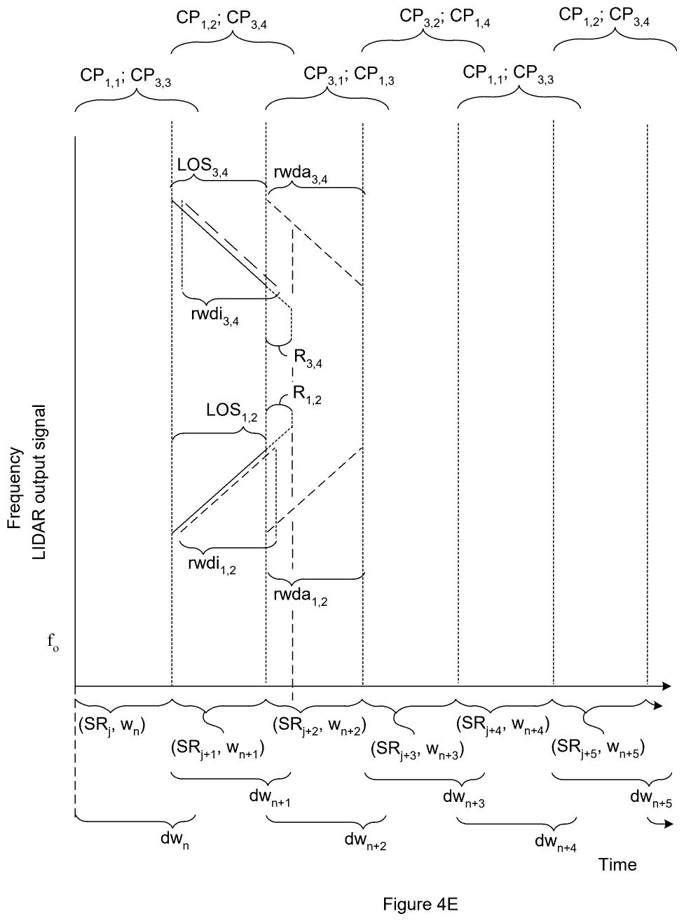

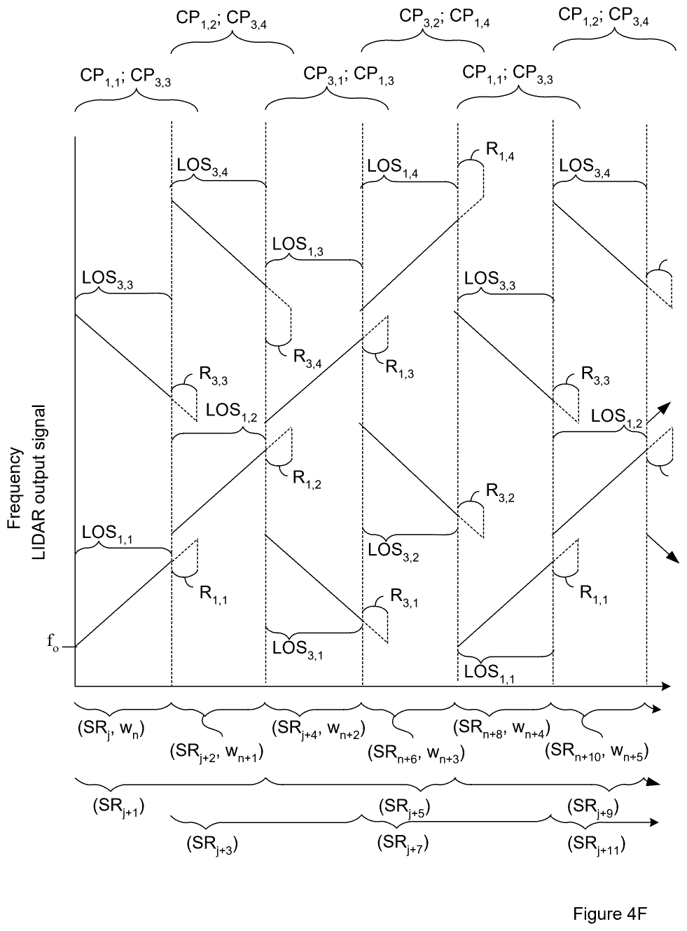

FIG. 4A illustrates an example of a composite signal generator 32 that is suitable for use as any, all, or each of the composite signal generators 32 in the LIDAR chip of FIG. 1 and/or FIG. 1B. The illustrated composite signal generator 32 includes a light signal combiner 140 configured to receive light signals from one of the reference waveguides 36 and one of the comparative waveguides 30. When the reference waveguide 36 receives a reference signal, the reference waveguide 40 carries the reference signal to the light signal combiner 140. When a channel waveguide 30 receives a comparative signal, the channel waveguide 30 carries the comparative signal to the light signal combiner 140. When the light signal combiner 140 receives a comparative signal and a reference signal, the light signal combiner 140 combines the comparative signal and the reference signal into a composite signal. Due to a difference in frequencies between the comparative signal and the reference signal, the composite signal is beating at a beat frequency.

The light signal combiner 140 also splits the composite signal onto a first detector waveguide 142 and a second detector waveguide 144. The first detector waveguide 142 carries a first portion of the composite signal to a first light sensor 146 that converts the first portion of the composite signal to a first electrical signal. The second detector waveguide 144 carries a second portion of the composite signal to a second light sensor 148 that converts the second portion of the composite signal to a second electrical signal. Examples of suitable light sensors include germanium photodiodes (PDs), and avalanche photodiodes (APDs).

In some instances, the light signal combiner 140 splits the composite signal such that the portion of the comparative signal included in the first portion of the composite signal is phase shifted by 180° relative to the portion of the comparative signal in the second portion of the composite signal but the portion of the reference signal in the first portion of the composite signal is not phase shifted relative to the portion of the reference signal in the second portion of the composite signal. Alternately, the light signal combiner 140 splits the composite signal such that the portion of the reference signal in the first portion of the composite signal is phase shifted by 180° relative to the portion of the reference signal in the second portion of the composite signal but the portion of the comparative signal in the first portion of the composite signal is not phase shifted relative to the portion of the comparative signal in the second portion of the composite signal.

As shown in FIG. 1 and FIG. 1B, the LIDAR chip can include multiple composite signal generator 32. FIG. 4B illustrates an example of a portion of the electronics configured to process the output from a composite signal generator 32. The electronics 56 can connect the first light sensor 146 and the second light sensor 148 in each of the composite signal generators 32 as a balanced detector that serves as a light detector 149 that converts optical energy to electrical energy. As noted above, the different composite signal generators 32 are associated with different channel indices. Accordingly, the light detectors in different composite signal generator 32 are each associated with a different one of the channel indices.

The light detector is in electrical communication with a detector output line 154 that carries the output signal of the light detector as a data signal. For instance, the serial connection in the balanced detectors is in communication with one of the detector output lines 154. The electronics 56 include a data processor 155 configured to generate LIDAR data for a sample that indicates a radial velocity and/or distance between the LIDAR system and an object in the sample region. The data processor 155 includes a beat frequency identifier 158 that receives the data signal and is configured to identify the beat frequency of the data signal. The beat frequency identifier 158 includes an Analog-to-Digital Converter (ADC) 168 that receives the data signal from the detector output lines 154. The Analog-to-Digital Converter (ADC) 168 converts the data signal from an analog form to a digital form and outputs a digital data signal. The digital data signal is a digital representation of the data signal.

The beat frequency identifier 166 includes a mathematical transformer 170 configured to receive the digital data signal. The mathematical transformer 170 is configured to perform the mathematical operation on the received digital data signal. Examples of suitable mathematical operations include, but are not limited to, mathematical transforms such as Fourier transforms. In one example, the mathematical transformer 170 performs a Fourier transform on the digital signal so as to convert from the time domain to the frequency domain. The mathematical transform can be a real transform such as a real Fast Fourier Transform (FFT). A real Fast Fourier Transform (FFT) can provide an output that indicates magnitude as a function of frequency.

The mathematical transformer 170 can include a peak finder (not shown) configured to identify peaks in the output of the mathematical transformer 170. The peak finder can be configured to identify any frequency peaks associated with reflection of the system output signal by one or more objects located outside of the LIDAR system. For instance, frequency peaks associated with reflection of the system output signal by one or more objects located outside of the LIDAR system can fall within a frequency range. The peak finder can identify the frequency peak within the range of frequencies associated with the reflection of the system output signal by one or more objects located outside of the LIDAR system. The frequency of the identified frequency peak represents the beat frequency of the composite signal.

The electronics include a LIDAR data generator 172 that receives the output from the mathematical transformer 170. For instance, the beat frequency from the LIDAR data generator 172. The LIDAR data generator 172 treats the frequency at the identified peak as the beat frequency of the comparative signal beating against all or a portion of a reference signal. Although FIG. 4B illustrates the LIDAR data generator 172 receiving the output from a single mathematical transformer 170, the LIDAR data generator 172 can receive the beat frequencies from other mathematical transformers 170. For instance, the LIDAR data generator 172 can receive the beat frequencies from the mathematical transformer 170 included in other beat frequency identifier 158. Since different beat frequency identifier 158 can receive composite signals from composite signal generators 32 that are associated with different channels, the LIDAR data generator 172 can receive the beat frequencies that are associated with different channels. The LIDAR data generator 172 can use the received beat frequencies in combination with the frequency pattern of the LIDAR output signal and/or the system output signal to generate LIDAR data results.

FIG. 4C illustrates an example of suitable frequency patterns for the outgoing LIDAR signals. The light source controller 62 can operate the light source 10 such that the outgoing LIDAR signals output from the light source 10 have a frequency versus time pattern according to FIG. 4C. There are four frequency versus time patterns shown in FIG. 4C. Each of the frequency versus time patterns is associated with one of the channel indices as shown by the labels m=1 through m=4. The frequency versus time pattern m can represent the frequency versus time pattern for the outgoing LIDAR signal associated with the channel m.

The frequency versus time patterns can be periodic as shown in FIG. 4C. For instance, FIG. 4C labels different cycles for the outgoing LIDAR signal associated with channel index m=1 through m=4. The different cycles are labeled cycleⱼ and cycleⱼ₊₁. The frequency versus time patterns associated with different channel indices can have cycles with the same duration.

Each of the outgoing LIDAR signals has a frequency versus time pattern that periodically repeats in cycles. Each cycle includes multiple active chirp periods labeled ac. Each cycle includes none, one, or more than one connecting chirp periods. In some instances, all or a portion of the connecting chirp periods are each between active chirp periods. Each of the cycles shown in FIG. 4C includes two active chirp periods and two connecting chirp periods. For instance, in FIG. 4C, the frequency versus time pattern for the outgoing LIDAR signal associated with alternate waveguide index m=1 has cycles that each includes two active chirp periods labeled ac and two connecting chirp periods labeled ic. The connecting chirp periods are between active chirp periods and can serve as transitions between different active chirp periods. As a result, the chirp rate and/or chirp direction during connecting chirp periods can be constant, but need not be constant. In some instances, the chirp rate during all or a portion of the connecting chirp periods is zero, or substantially zero as shown in FIG. 4C. The portion of an outgoing LIDAR signal that serves as an active chirp period is used in the calculation of LIDAR data. In contrast, the portion of an outgoing LIDAR signal that serves as an active chirp period is not used in the calculation of LIDAR data. The connecting chirp periods are optional. As a result, the active chirp periods can be continuous with one another. The duration of different chirp periods in the same cycle can be different. For instance, the active chirp periods shown in the cycles of FIG. 4C have the same duration. The connecting chirp periods shown in the cycles of FIG. 4C have the same duration. The active chirp periods have a different duration than the connecting chirp periods.

The chirp rate of each outgoing LIDAR signal is constant, or substantially constant, during each of the active chirp periods in a cycle. Each of the outgoing LIDAR signals can have different chirp rates and/or different chirp directions in the different active chirp periods of the cycles of the outgoing LIDAR signal. As shown in FIG. 4C, the chirp rate of each outgoing LIDAR signal can be optionally constant, or substantially constant, during each of the connecting chirp periods in a cycle; however, a constant chirp rate is not required during connecting chirp periods. Connecting chirp periods are optional.

The LIDAR system is also configured to output multiple system output signals. Each of the system output signals includes light from one of the outgoing LIDAR signals and different system output signals include light from different outgoing LIDAR signals. The duration for the output of each system output signal can be less than or equal to the duration of one or more of the active chirp periods in the cycles of the outgoing LIDAR signal that is a source of the light included in the system output signal.

Each of the illustrated cycles for the different outgoing LIDAR signals includes K=4 chirp periods. The start time of each cycle coincides with the start of one of the chirp periods in the cycle. The chirp periods in the cycle of a frequency versus time pattern can be associated with a chirp period index k with a value from k=1 to K. In FIG. 4C, each chirp period is labeled CP_{k,m} where m represents the channel index and k is a chirp period index. Accordingly, CP_{1,2} represents the first chirp period for the outgoing LIDAR signal associated with channel index m=2. In some instances, the duration of each chirp period in a cycle associated with a first one of channel indices matches the duration of a chirp period the cycles associated with all or a portion of the other channel indices. For instance, in FIG. 4C, the duration of chirp period CP_{1,1} can be equal to the duration of chirp period CP_{1,2} and the duration of chirp period CP_{2,1} can be equal to the duration of chirp period CP_{2,2}. In some instances, the chirp direction and chirp rate of the chirp periods associated the same channel index are the same. In some instances, the chirp direction and chirp rate of the active chirp periods associated with the same channel index are the same. In some instances, all or a portion of the active chirp periods, in each cycle has a duration in a range from 0.1 μs, 1 μs, or 2 μs to 5 μs, 10 μs, or 100 μs.

The total change in the frequency that occurs during a chirp period can be considered a magnitude of the frequency change during the chirp period (chirp bandwidth). The chirp bandwidth during the active chirp periods in the same cycle can be the same or different. In FIG. 4C, the chirp bandwidth during each of the active chirp periods is constant or substantially constant; however, a portion of the chirp periods have different directions for the total change in the frequency that occurs during a chirp period.

FIG. 4C illustrates each of the outgoing LIDAR signals having different wavelengths. A difference in the wavelengths of the outgoing LIDAR signals shown in FIG. 4C can produce a shift upward or downward in one or both of the illustrated frequency versus time patterns.

Although FIG. 4C illustrates the cycles including two active chirp periods, the cycles can include more than two chirp periods. A portion of the active chirp period in a cycle can have a chirp rate of zero, or substantially zero. For instance, all or a portion of the cycles can have one or more active chirp periods with a chirp rate of zero, or substantially zero. Active chirp periods with a chirp rate of zero, or substantially zero, have a frequency versus time pattern that is horizontal, or substantially horizontal. In some instances, each cycle includes at least one, or at least two, active chirp periods with a non-zero chirp rate.

The selector controller 76 operates the signal selector 16 so as to select the outgoing LIDAR signal that serves as the LIDAR output signal output from the LIDAR chip and accordingly as the source for the system output signal output from the LIDAR system. For instance, the signal selector 16 can be operated so as to define output windows such that different selections of the outgoing LIDAR signals are output from the signal selector 16 and/or the LIDAR during each of the output windows. The output windows can occur in series such that different selections of the LIDAR output signals are serially output from the LIDAR chip and accordingly different selections of system output signals are serially output from the LIDAR system.

The signal selector 16 can be operated such that outgoing LIDAR signals associated with different channel indices alternately serve as the LIDAR output signal output from the LIDAR chip and accordingly different system output signals output from the LIDAR system. For instance, LIDAR output signals output from the LIDAR chip can alternate between different selections of channel indices. As an example, FIG. 4D illustrates the frequency versus time pattern of LIDAR output signals that can result from the signal selector 16 operating on outgoing LIDAR signals having the frequency versus time pattern of FIG. 4C.

The signal selector 16 is operated so as to alternate between selecting the outgoing LIDAR signals associated with channel index m=1 and m=3 to serve as a first selection of the LIDAR output signal and selecting the outgoing LIDAR signal associated with channel index m=2 and m=4 to serve as a second selection of the LIDAR output signals. As a result, the LIDAR output signals, and the resulting system output signals, alternate between the first selection of the LIDAR output signals and the second selection of the LIDAR output signals. Accordingly, the LIDAR output signals, and the resulting system output signals, alternate between the channel indices associated with the first selection of the LIDAR output signals and the channel indices associated with the second selection of the LIDAR output signals.

The signal selector 16 is operated such that the duration of each LIDAR output signal being transmitted is less than the chirp period for the outgoing LIDAR signal that is the source of the LIDAR output signal. For instance, the active chirp periods from FIG. 4C are labeled at the top of FIG. 4D. Each of the active chip periods includes a transmission window and a reference window. The transmission windows are labeled LOS_{k,m} where m represents the channel index and k is the chirp period index. The reference windows are labeled R_{k,m} where m represents the channel index and k is the chirp period index. The portion of an outgoing LIDAR signal falling within a transmission window can be considered a transmission segment of the outgoing LIDAR signal and the portion of an outgoing LIDAR signal falling within a reference window can be considered a reference segment of the outgoing LIDAR signal. Since each of the reference signals include a portion of the light from an outgoing LIDAR signal received by a splitter 34 (a preliminary outgoing LIDAR signal), the reference signals also include transmission segments and reference segments that correspond to the transmission segments and the reference segments in the outgoing LIDAR signal received by the splitter. The signal selector is operated such that the LIDAR output signals and the system output signals include light from the transmission segment of the outgoing LIDAR signal but exclude light from the reference segment of the outgoing LIDAR signal. Accordingly, the LIDAR output signals and the system output signals exclude reference segments.

The signal selector 16 is operated such that each LIDAR output signal is output during the associated transmission window. For instance, the signal selector 16 is operated such that the outgoing LIDAR signal associated with chirp period CP_{k,m} is output from the signal selector 16 during the transmission windows labeled LOS_{k,m} but not during the reference window labeled R_{k,m}. Since the LIDAR output signals and the system output signals include light from an outgoing LIDAR signal output from the signal selector 16, the LIDAR output signal that includes light from the outgoing LIDAR signal associated with chirp period CP_{k,m} is output from the signal selector 16 during the transmission windows labeled LOS_{k,m} but not during the reference window labeled R_{k,m}. As an example, the LIDAR output signal output during LOS_{1,2} includes or consists of light from the outgoing LIDAR signal generated during chirp period CP_{1,2}. Since the transmission windows (LOS_{k,m}) are each shorter than the associated chirp windows CP_{k,m}, the signal selector 16 truncates the outgoing LIDAR signals and the truncated outgoing LIDAR signals serve as the LIDAR output signals and the system output signals. As is evident from FIG. 4D, the frequency versus time patterns for each of the LIDAR output signals is a fraction of the frequency versus time pattern of the chirp period associated with the LIDAR output signal. For instance, LOS_{k,m}<CP_{k,m}. In some instances, the duration of each LIDAR output signal is selected such that the duration of each LIDAR output signal is equal to the duration of each cycle/K. In some instances, the signal selector 16 is operated such that LOS_{k,m} is greater than 50%, 60%, or 70% and less than 80%, 85%, or 90% of CP_{k,m} for all or a portion of the possible combinations of k and m.

The signal selector can be operated so as to stop the output of an outgoing LIDAR signal from the signal selector even though the signal selector is still receiving the outgoing LIDAR signal. For instance, the light source can continue to output an outgoing LIDAR signal that is received by the signal selector but not output from the signal selector. As is evident from FIG. 1, operating the signal selector so as to stop an output of an outgoing LIDAR signal from being output by the signal selector does not stop the associated reference signal from traveling to the associated composite signal generator 32. Since the light source can continue to output each of the outgoing LIDAR signal while the signal selector is operated such that a portion of the outgoing LIDAR signals are not output from the signal selector, each composite signal generator 32 continues to receive a reference signal after the signal selector 16 stops outputting the outgoing LIDAR signal that is the source of the comparative signal that is the source of the comparative signal received by the composite signal generator 32. Accordingly, each composite signal generator 32 associated with channel index m continues to receive the reference signal associated with channel index m after the signal selector 16 stops outputting the outgoing LIDAR signal associated with channel index m, after the after the LIDAR chip stops outputting the LIDAR output signal associated with channel index m, and/or after the after the LIDAR system stops outputting the system output signal associated with channel index m. Accordingly, each of the composite signal generators 32 associated with one of the channel indices m receives the reference signal associated with channel index m while the signal selector 16 is not outputting the outgoing LIDAR signal associated with channel index m, while the LIDAR chip is not outputting the LIDAR output signal associated with channel index m, and/or while the LIDAR system is not outputting the system output signal associated with channel index m.

The reference signals associated with chirp period CP_{k,m} are output from the splitter 34 and/or received at the composite signal generator 32 during the transmission windows labeled LOS_{k,m}. However, the reference signals associated with chirp period CP_{k,m} are also output from the splitter 34 and/or received at the composite signal generator 32 during the reference windows labeled R_{k,m}. To illustrate this in FIG. 4D, the LIDAR output signals transmitted during the transmission windows LOS_{k,m} are extended to include a dashed line that shows the reference signal that continues to be output from the splitter 34 and/or received at the composite signal generator 32 during the chirp period CP_{k,m}. Accordingly, the dashed lines can represent the frequency versus time pattern for the reference signals during the reference windows (R_{k,m}). In some instances, the signal selector 16 is operated such that R_{k,m} is greater than 10%, 15%, or 20% and less than 30%, 40%, or 50% of CP_{k,m} for all or a portion of the possible combinations of k and m.

FIG. 4D shows multiple output windows labeled wₙ wherein n represents an output window index. The output windows are arranged serially in time. Additionally, there are multiple transmission windows LOS_{k,m} in each output window labeled wₙ. For instance, the output windows labeled Wₙ₊₁ includes the transmission windows labeled LOS_{1,2} and LOS_{3,4}. The duration of each output window matches the durations of the transmission windows that fall within the output window. Accordingly, the duration of each LIDAR output signal within an output window can be the same. Each of the transmission windows in an output window are associated with a different channel. Accordingly, during each output window, there are multiple outgoing LIDAR signals that are each associated with a different channel output from the signal selector 16, multiple LIDAR output signals that are each associated with a different channel output from the LIDAR chip and/or multiple system output signals that are each associated with a different channel output from the LIDAR system. Since each of the LIDAR output signals includes light from an active chirp period, each of the LIDAR output signals has a constant chirp rate. The chirp rates and/or chirp directions of the LIDAR output signals within the same output window can be different. For instance, FIG. 4D illustrates each of the LIDAR output signals within the same output window have different chirp directions but the same chirp rate. Accordingly, each output window has a LIDAR output signal with an upchirp and a LIDAR output signal with a downchirp.

Although FIG. 4D is disclosed in the context of outgoing LIDAR signals, each of the LIDAR output signals and the system output signals includes light from one of the outgoing LIDAR signals selected by the signal selector. As a result, the frequency versus time pattern disclosed in FIG. 4D can also represent the frequency versus time pattern of the LIDAR output signals output from the LIDAR chip and the system output signals transmitted from the LIDAR system. Accordingly, the system output signals can be transmitted from the LIDAR system as shown in FIG. 4D and/or the LIDAR output signals can be output from the LIDAR chip as shown in FIG. 4D. Accordingly, the LOS_{k,m} labels can represent the transmission windows for the system output signals and/or the LIDAR output signals.

The output windows wₙ shown in FIG. 4D are also shown in FIG. 4C. Each of the outgoing LIDAR signals is out of phase with two other outgoing LIDAR signals by the duration of one output window. As a result, the cycle for each outgoing LIDAR signal starts after a delay of one output window from the start of the prior cycle. The outgoing LIDAR signals of FIG. 4C have different frequency offsets. While corresponding active chirp periods in different outgoing LIDAR signals can have different bandwidths, FIG. 4D illustrates the corresponding active chirp periods in different outgoing LIDAR signals as having the same bandwidth. As a result, the frequency versus time pattern for each of the different channels can be the same but with different frequency offsets while being out of phase by the duration of one output window.

FIG. 4E shows the frequency versus time patterns for the LIDAR output signals during the output window labeled wₙ₊₁ in FIG. 4D. The frequency versus time patterns for the remaining LIDAR output signals have been removed from FIG. 4E in order to simplify the illustration. As a result, the frequency versus time pattern for the LIDAR output signal and the associated reference signal output during the transmission window LOS_{1,2} are shown by the solid line associated with the transmission window label LOS_{1,2}. The frequency versus time pattern for the LIDAR output signal and the associated reference signal output during the transmission window LOS_{3,4} is shown by the solid line associated with the transmission window labeled LOS_{3,4}. FIG. 4E also shows the frequency versus time pattern for the reference signals associated with the LIDAR output signals output during LOS_{1,2} and LOS_{3,4}. For instance, the dashed line associated with the reference window labeled R_{3,4} shows the frequency versus time pattern for the reference signal during the reference window R_{3,4}. The dashed line associated with the reference window labeled R_{1,2} shows the frequency versus time pattern for the reference signal during the reference window R_{1,2}.

The shortest distance that a reflecting object can be positioned from the LIDAR system with the LIDAR system providing reliable LIDAR data can be represented by “di.” When the object is positioned a distance “di” from the LIDAR system and is illuminated by a LIDAR output signal output during LOS_{k,m}, the window of time during which the resulting LIDAR input signal is received by the LIDAR system can be labeled rwdi_{k,m}. As an example, FIG. 4E has a time window labeled rwdi_{1,2} and the dashed line within this time window represents the frequency versus time pattern of a LIDAR input signal that results from the LIDAR output signal output during LOS_{1,2} being reflected by an object positioned at “di.” As another example, FIG. 4E has a time window labeled rwdi_{3,4} and the dashed line within this time window represents the frequency versus time pattern of a LIDAR input signal that results from the LIDAR output signal output during LOS_{3,4} being reflected by the object positioned at “di.” The distance between the signals represented by the solid line and the resulting signals represented by dashed lines is a result of the LIDAR output signal traveling from the LIDAR system to the object and then from the object to the LIDAR system. For instance, the distance between the signal represented by the solid line under the time window label LOS_{1,2} and the dashed line in the time window labeled rwdi_{3,4} in FIG. 4E is a result of the LIDAR output signal traveling from the LIDAR system to the object and then from the object to the LIDAR system.

The longest distance that a reflecting object can be positioned from the LIDAR system with the LIDAR system providing reliable LIDAR data can be represented by “da.” When the object is positioned a distance “da” from the LIDAR system and is illuminated by a LIDAR output signal output during LOS_{k,m}, the window of time during which the resulting LIDAR input signal is received the LIDAR system can be labeled rwda_{k,m}. As an example, FIG. 4E has a time window labeled rwda_{1,2} and the dashed line within this time window represents the frequency versus time pattern of a LIDAR input signal that results from the LIDAR output signal output during LOS_{1,2} being reflected by an object positioned at “da.” As another example, FIG. 4E has a time window labeled rwda_{2,2} and the dashed line within this window represents the frequency versus time pattern of a LIDAR input signal that results from the LIDAR output signal output during LOS_{3,4} being reflected by the object positioned at “da.” The distance between the signals represented by the solid line and the resulting signals represented by dashed lines is a result of the LIDAR output signal traveling from the LIDAR system to the object and the reflected light traveling from the from the object to the LIDAR system. For instance, the distance between the signal represented by the solid line under the time window label LOS_{1,2} and the dashed line in the time window labeled rwda_{1,2} in FIG. 4E is a result of the LIDAR output signal traveling from the LIDAR system to the object and then from the object to the LIDAR system. The frequency versus time pattern of the LIDAR input signals shown in FIG. 4E can also represent the frequency versus time pattern of the comparative signals that results from the LIDAR input signals.

Although FIG. 4E shows no overlap between the return window rwdi_{k,m} and the return window rwda_{k,m}, in some instances, the return window rwdi_{k,m} overlaps the return window rwda_{k,m}.

In order for a beat frequency identifier 158 to identify the beat frequency of a composite signal, the data signal needs to have a contribution from a comparative signal and a reference signal. FIG. 4E labels different measurement windows where the beat frequency of the data signal, and accordingly the beat frequency of the composite signal, can be identified as dwₙ where n represents the output window index. Each of the measurement windows is associated with one of the output windows. For instance, the measurement window labeled dwₙ₊₁ can be used to determine the beat frequency of the comparative signal that includes or consists of light from the LIDAR output signals output during the associated output window wₙ₊₁.

The measurement windows dwₙ are positioned to at least partially overlap the return windows (rwdi_{k,m} and rwda_{k,m}) for each of the LIDAR output signals output during output window wₙ. For instance, FIG. 4E shows the measurement window labeled dwₙ₊₁ positioned to overlap return windows for the LIDAR output signals output during output window wₙ₊₁ (rwda_{1,2}, rwdi_{1,2}, rwda_{3,4}, rwdi_{3,4}). As a result, when the object is within the range extending from “di” to “da” during the output of LIDAR output signals during output window wₙ, the LIDAR system receives the resulting LIDAR input signal during the measurement window dwₙ. For instance, when a reflecting object within the range extending from “di” to “da” is illuminated by a LIDAR output signal associated with m=1 output during output window wₙ₊₁ (i.e. LOS_{1,2} in FIG. 4E) and a LIDAR output signal associated with m=3 that is also output during output window wₙ (i.e. LOS_{3,4} in FIG. 4E), the LIDAR system receives at least a portion of the resulting LIDAR input signal associated with m=1 during the measurement window dwₙ₊₁ and also receives at least a portion of the resulting LIDAR input signal associated with m=3 during the measurement window dwₙ₊₁. Since the LIDAR input signals are each the source of the comparative signal, the resulting comparative signals become available for use in the comparative signal during the associated measurement window.

The measurement windows can optionally extend to the to the end of the associated reference window. For instance, in FIG. 4E, the reference signal associated with channel index m=4 is output from the splitter 34 and/or received at the composite signal generator 32 during the output window LOS_{3,4} and the reference window labeled R_{3,4}. Similarly, the reference signal associated with channel index m=2 is output from the splitter 34 and/or received at the composite signal generator 32 during the output window LOS_{1,2} and the reference window labeled R_{1,2}. The associated measurement window (labeled dwₙ₊₁) extends to the end of the reference windows (R_{1,2} and R_{3,4}). As a result, the reference signal can be available for use in the comparative signal for the duration of the measurement window. Accordingly, during the measurement window, the reference signal and the comparative signal associated with the same channel index are present in the comparative signal generated by the composite signal generators 32 associated with the same channel index. For instance, in the case of FIG. 4E, during the measurement window dwₙ₊₁, the reference signal output during transmission window LOS_{3,4} and reference window R_{3,4} are received by the composite signal generators 32 associated with channel index m=4; and when an object is within the range extending from “di” to “da” during the output of the LIDAR output signal associated with transmission window LOS_{3,4} during the measurement window dwₙ₊₁, the composite signal generators 32 associated with channel index m=4 receives the comparative signal that includes light from the LIDAR output signal associated with transmission window LOS_{3,4}. Since the comparative signal includes a contribution from the reference signal and the comparative signal, the comparative signal is beating at the beat frequency.

As shown by the labels at the bottom of FIG. 4E, the duration of the measurement windows can exceed the duration of the associated output window. For instance, the duration of dwₙ can be >the duration of wₙ. In some instances, the duration of the measurement windows is less than the duration of the associated output window. For instance, FIG. 4E shows the measurement window opening at the start of the associated output window. However, the measurement windows can open after the opening of the associated output window. For instance, the measurement windows can open at, or after, the opening of the associated return window rwdi_{k,m}. In some instances, all or apportion of the measurement windows are configured such that duration of the measurement windows more than 5%, 10%, or 20% and less than 30%, 40%, or 50% of the duration of the associated output window.

As shown in FIG. 4E, the construction of the LIDAR system allows the measurement windows to be arranged in parallel rather than in series. As a result, the measurement windows can overlap one another in time. In some instances, all or a portion of the measurement windows each serves as an overlapping measurement window that overlaps one more other measurement windows by more than 5%, 10%, or 20% and less than 30%, 40%, or 50% of the duration of the overlapping measurement window.

The extension of the reference signal output beyond the output of the outgoing LIDAR signal from the signal selector, beyond the output of the LIDAR output signal from the LIDAR chip and/or beyond the transmission of the system output signals from the LIDAR system can increase the duration of the measurement window and/or increase the distances for which LIDAR data can be reliably calculated. As is evident from FIG. 4E, the measurement window dwₙ₊₁ extends beyond the associated output window wₙ₊₁. The ability to extend the measurement window beyond the output window can increase the time available to identify a beat frequency and accordingly increases the reliability of the LIDAR data results. Additionally, the ability to extend the measurement window beyond the output window allows for the identification of the beat frequency when there are longer delays in the return of the system return signal. Accordingly, extension of the measurement window beyond the output window can permit generation of reliable LIDAR data for longer object distances.

Although FIG. 4E is disclosed in the context of a single output window for the purposes of simplicity, the disclosure of FIG. 4E can be extended to each of the output windows.

A LIDAR data generator 172 can combine the frequencies from multiple different composite signal generators 32 to generate LIDAR data for a sample region. The combined beat frequencies can be from the same measurement window. Accordingly, the combined beat frequencies can be from system output signals transmitted during the same output window. For instance, a LIDAR data generator 172 can generate LIDAR data for the sample region illuminated by the system output signals transmitted from the LIDAR system during output window wₙ₊₁ in FIG. 4D (the system signals output during output windows LOS_{1,2} and LOS_{3,4}.) by using the beat frequencies of the composite signals during measurement window dwₙ₊₁ in FIG. 4E. Accordingly, a LIDAR data generator 172 can receive the beat frequencies from the beat frequency identifier 158 associated with channel index m=2 and the beat frequency identifier 158 associated with channel index m=4. The LIDAR data generator 172 can also receive the beat frequencies from the beat frequency identifier 158 associated with channel index m=1 and the beat frequency identifier 158 associated with channel index m=3 or the LIDAR system can include a second LIDAR data generator 172 that receives the beat frequencies from the beat frequency identifiers 158 associated with channel index m=1 and the beat frequency identifier 158 associated with channel index m=3.

The following equation applies to a system output signal where the frequency of the system output signal carrying that channel increases during the sample period such as occurs with the LIDAR output signal output during transmission window LOS_{1,2} of FIG. 4E during output window wn₊₁: +f_{ub}=f_{d}+ατ₀ where f_{ub} is the beat frequency output from the mathematical transformer 170 associated with the same channel as the system output signal, f_{d} represents the Doppler shift (f_{d}=^{2vf}c/_{c}) where f_{c} is the frequency of the LIDAR output signal at the start of the output window, v is the radial velocity between the reflecting object and the LIDAR chip where the direction from the reflecting object toward the chip is assumed to be the positive direction, and c is the speed of light, □ represents the rate at which the frequency of the outgoing LIDAR signal is increased or decreased during the sample period, and τ₀ is the roundtrip delay (time between the system output signal exiting from the LIDAR system and the system return signal returning to the LIDAR system) for a stationary reflecting object. The following equation applies to a system output signal where the frequency of the system output signal carrying that channel decreases during the sample period such as occurs with the transmission window LOS_{3,4} of FIG. 4E during output window w_{n+!}::−f_{ab}=−f_{d}−ατ₀ where f_{db} is the beat frequency output from the mathematical transformer 170 associated with the same channel as the system output signal. In these two equations, f_{d} and τ₀ are unknowns. These two equations are solved for the two unknowns f_{d} and τ₀. The values of f_{db} and f_{ub} that are substituted into the solution come from different composite signal generators 32 (labeled 32 in FIG. 1) because the value of f_{db} is generated from a LIDAR output signal carrying a different channel than the LIDAR output signal from which the value of f_{ub} is generated. The different channels are concurrently incident on the same sample region(s) during the output window. As a result, the LIDAR data generator 172 can calculate the radial velocity for an object in the sample region from the Doppler shift ((v=c*f_{d}/(2f_{c})) and/or the separation distance for the object in the sample region from c*τ₀/2. As a result, the LIDAR data for a single sample period can be determined using channels received at different processing components.

When the LIDAR data is generated from system output signals transmitted during the same output window, the portion of the field of view illuminated by the system output signals transmitted during that output window serves as the sample region. Accordingly, the LIDAR data generated for those system output signals is the LIDAR data for that sample region. As a result, each of the output windows can be associated with a sample region. In FIG. 4D and FIG. 4E, the sample regions are labeled SRⱼ where j represents a sample region index. As shown in FIG. 4D, the sample region indices correspond to the output window indices.

LIDAR data can be calculated from beat frequencies generated from different measurement windows. Since different measurement windows are associated with different output windows, the LIDAR data generator 172 can use beat frequencies that result from system output signals transmitted during different output windows. As an example, FIG. 4F shows the frequency versus time patterns for the LIDAR output signals of FIG. 4D modified to include sample regions that are associated with multiple output windows that are adjacent to each other in time. The LIDAR data for a sample region associated with multiple output windows can be calculated using the solutions for f_{d} and τ₀ where f_{ub} and f_{ub} are the beat frequencies from different measurement windows. As an example, when calculating the LIDAR data for the sample region labeled SRⱼ₊₃, f_{ub} can be the beat frequency for the composite signal generated from the LIDAR output signal output during transmission window LOS_{1,2} and f_{db} can be the beat frequency for the composite signal generated from the LIDAR output signal output during transmission window LOS_{3,1}. Alternately, f_{ub} can be the beat frequency for the composite signal generated from the LIDAR output signal output during transmission window LOS_{1,3} and f_{db} can be the beat frequency for the composite signal generated from the LIDAR output signal output during transmission window LOS_{3,4}. As a result, the LIDAR data for the sample region labeled SRⱼ₊₃ is generated from a system output signal transmitted during output window wₙ₊₁ and output window wₙ₊₂. Accordingly, the LIDAR data for the sample regions associated with multiple output windows are generated from system output signals transmitted during each of the output windows associated with the sample region. As is evident from a comparison of the number of sample regions shown in FIG. 4E and FIG. 4F, calculating LIDAR data from beat frequencies calculated from different measurement windows in combination with calculating LIDAR data from beat frequencies calculated from the same measurement window increases the number of LIDAR data results that can be generated within the same period of time.

FIG. 4B illustrates a single LIDAR data processor 172 in the data processor 155. The LIDAR data processor can receive the beat frequencies from the beat frequency identifiers 158 associated with each of the different channels. As a result, the LIDAR data processor 172 can generate the LIDAR data for each of the different sample regions. Alternately, the data processor 155 can include multiple LIDAR data processors 172 that each receives the beat frequencies from the beat frequency identifiers 158 associated with different selections of the channels. Accordingly, each of the LIDAR data processors 172 can receive beat frequencies associated with a different selection of the channels. As a result, different LIDAR data processors 172 can generate LIDAR data results for different sample regions.

Although the LIDAR system is disclosed in the context of a LIDAR system having four wavelength channels, the LIDAR system can include more than 4 channels or less than 4 channels. For instance, the LIDAR system can have a single channel. For instance, when a LIDAR system has a single channel, the LIDAR data for each sample region can be calculated by using the beat frequencies from output windows that separated by another output window in FIG. 4F. For instance, a LIDAR system having only channel m=2 can generate LIDAR data for a first sample region from the beat frequencies generated from output windows labeled wₙ₊₁ and wₙ₊₃ in FIG. 4F and/or for a second sample region from the beat frequencies generated from output windows labeled wₙ₊₃ and wₙ₊₅ in FIG. 4F. As another example, the LIDAR system can have two channels. When the LIDAR system has two channels, the LIDAR data for each sample region can be calculated by using the beat frequencies from the same output windows. For instance, a LIDAR system having only channel m=1 and channel m=3 can generate LIDAR data for the sample region labeled SRⱼ in FIG. 4F from the beat frequencies generated from output window wₙ and/or for the sample region labeled SRⱼ₊₄ in FIG. 4F from the beat frequencies generated from output window wₙ₊₂. These examples illustrate that reducing the number of channels can reduce the resolution of the LIDAR. Additional channels can also be added to further refine the LIDAR data.

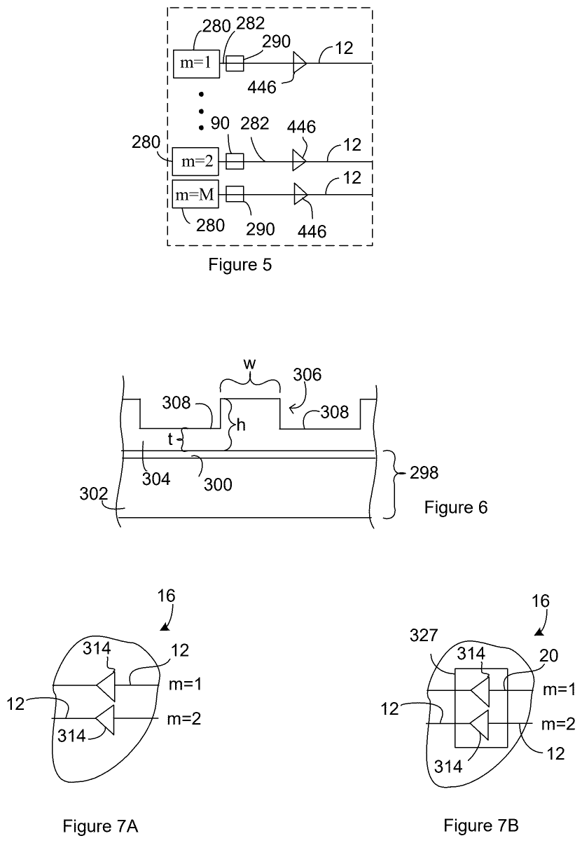

FIG. 5 illustrates an example of a light source 10 suitable for use in conjunction with the LIDAR system. The light source 10 includes multiple laser sources 280. Each of the laser sources 280 is configured to output a channel signal on a source waveguide 282. The different channel signals can have different wavelengths. Accordingly, the resulting outgoing LIDAR signals can have different wavelengths.

Each laser source 280 can be associated with a different channel index. For instance, the laser source 280 associated with channel index m=1 is labeled m=1 and the laser source 280 associated with channel index m=2 is labeled m=2. The laser source 280 associated with channel index m outputs a channel signal associated with channel index m. A suitable laser source 280 includes, but is not limited to, semiconductor lasers such as External Cavity Lasers (ECLs), Distributed Feedback lasers (DFBs), Discrete Mode (DM) lasers and Distributed Bragg Reflector lasers (DBRs).

In some instances, each of the channel signals output from a laser source 280 serves as one of the outgoing LIDAR signals. The light source controller 62 can tune the frequency of the channel signal output from a laser source 280, and accordingly, the frequency of the resulting outgoing LIDAR signal, by tuning the electrical current through the laser source 280 and/or the bias level applied to the laser source 280. Since a different laser source 280 is the source of each outgoing LIDAR signal, the frequency patterns of the outgoing LIDAR signals and the resulting system output signals can be independently tuned.

The light source 10 can optionally include one or more modulators 290 that are each positioned so as to modulate one of the channel signals. For instance, the light source 10 can optionally include one or more modulators 290 positioned along each of the source waveguides 282. When the light source 10 includes one or more modulators 290, the light source controller 62 can tune the frequency of the channel signal output from a laser source 280, and accordingly, the frequency of the resulting outgoing LIDAR signal, by tuning the electrical current through the modulator 290 and/or the bias level applied to the modulator 290. Since different modulators 290 can be operated to modulate the frequency patterns of different channel signals and the resulting outgoing LIDAR signals, the frequency patterns of the outgoing LIDAR signals and the resulting system output signals can be independently tuned. Suitable modulators 290 include, but are not limited to, thermal heaters, PIN carrier injection phase shifters, PN depletion-based phase shifters, and Mach-Zehnder modulators. An example of a suitable optical attenuator can be found in U.S. patent application Ser. No. 17/396,616, filed on Aug. 6, 2021, entitled “Carrier Injector Having Increased Compatibility,” and incorporated herein in its entirety.

The light source 10 can have a construction other than the construction illustrated in FIG. 5. For instance, the channel signals can be multiplexed onto an optical pathway such as an optical fiber or waveguide. The channel signals on the optical pathway can subsequently be demultiplexed into the outgoing LIDAR signals on the utility waveguides. The use of an optical fiber as the optical pathway allows the laser sources to be positioned off the LIDAR chip. The control branch 64 can have a construction other than the construction illustrated in FIG. 1. For instance, each of the control waveguides 68 can carry the control signal to a different feedback system 74 without carrying the control signal to an optical attenuator 70. Each of the feedback system 74 can be associated with a different one of the laser sources. During operation, the light source controller 62 can adjust the frequency of channel signals in response to output from the associated feedback system.

The LIDAR system can optionally include one or more light signal amplifiers in addition, or as an alternative, to any amplifiers 110. For instance, an amplifier 298 can optionally be positioned along a detector output line 154 as illustrated in FIG. 4B. Suitable amplifiers 298 for use on the LIDAR chip, include, but are not limited to, Semiconductor Optical Amplifiers (SOAs) and transimpedance amplifiers.

Suitable platforms for construction for a LIDAR chip include, but are not limited to, silicon-on-insulator wafers, silica wafers, and silicon nitride on silicon wafers. FIG. 6 illustrates a portion of a LIDAR chip that includes a waveguide with a construction that is suitable for use with chips constructed from silicon-on-insulator wafers. A ridge 306 of the light-transmitting medium 304 extends away from slab regions 308 of the light-transmitting medium 304. The light signals are constrained between the top of the ridge and the buried layer 300. As a result, the ridge 306 at least partially defines the waveguide.

The dimensions of the ridge waveguide are labeled in FIG. 6. For instance, the ridge has a width labeled w and a height labeled h. The thickness of the slab regions is labeled t. For LIDAR applications, these dimensions can be more important than other applications because of the need to use higher levels of optical power than are used in other applications. The ridge width (labeled w) is greater than 1 μm and less than 4 μm, the ridge height (labeled h) is greater than 1 μm and less than 4 μm, the slab region thickness is greater than 0.5 μm and less than 3 μm. These dimensions can apply to straight or substantially straight portions of the waveguide, curved portions of the waveguide and tapered portions of the waveguide(s). Accordingly, these portions of the waveguide will be single mode. However, in some instances, these dimensions apply to straight or substantially straight portions of a waveguide. Additionally, or alternately, curved portions of a waveguide can have a reduced slab thickness in order to reduce optical loss in the curved portions of the waveguide. For instance, a curved portion of a waveguide can have a ridge that extends away from a slab region with a thickness greater than or equal to 0.0 μm and less than 0.5 μm. While the above dimensions will generally provide the straight or substantially straight portions of a waveguide with a single-mode construction, they can result in the tapered section(s) and/or curved section(s) that are multimode. Coupling between the multi-mode geometry to the single mode geometry can be done using tapers that do not substantially excite the higher order modes. Accordingly, the waveguides can be constructed such that the signals carried in the waveguides are carried in a single mode even when carried in waveguide sections having multi-mode dimensions. The waveguide construction of FIG. 6 is suitable for all or a portion of the waveguides on the LIDAR chip.

An example of a suitable signal selector 16 includes amplifiers. FIG. 7A is schematic of an example of a suitable signal selector 16. The signal selector 16 includes amplifiers 314 that each receives an outgoing LIDAR signal from one of the utility waveguides 12. In FIG. 4A, the utility waveguides 12 serve as the selector waveguide shown in FIG. 1 and FIG. 1B. All or a portion of the amplifiers included in the signal selector 16 can be included in an amplifier chip. As an example, FIG. 7B is a schematic of a signal selector 16 that includes the amplifiers 314 on an amplifier chip 327. Each of the amplifiers is associated with one of the channel indices. The amplifier associated with channel index m receives the outgoing LIDAR signal associated with channel index m. Although FIG. 7B illustrates the signal selector 16 positioned along the length of the utility waveguides 12, the signal selector 16 can be positioned at the terminus of the utility waveguides 12 and/or at the edge of the LIDAR chip as illustrated in FIG. 1 and FIG. 1B.

The selector controller 76 can operate each of the amplifiers 314 so as to amplify the power of the outgoing LIDAR signals passing through the amplifier or to allow the preliminary outgoing LIDAR signal to pass through the amplifier without amplification. In some instances, operating an amplifier below an amplification threshold effectively causes attenuation of the preliminary outgoing LIDAR signal. As an example, Semiconductor Optical Amplifiers (SOAs) amplify a preliminary outgoing LIDAR signal when a forward bias is applied to the Semiconductor Optical Amplifier (SOA). When a reverse-bias is applied to the Semiconductor Optical Amplifiers (SOAs), a gain medium in the SOA absorbs at least a portion of the outgoing LIDAR signal and further attenuates the outgoing LIDAR signal. Accordingly, when the selector controller 76 operates one of the amplifiers 314 such that the electrical current through the gain medium falls below the current threshold, the amplifier 314 can attenuate the power of the outgoing LIDAR signal. As a result, the selector controller 76 can operate each of the amplifiers 314 such that the amplifier outputs an outgoing LIDAR signal that is amplified relative to the outgoing LIDAR signal received by the amplifier 314, that is unamplified relative to the outgoing LIDAR signal received by the amplifier 314, that is attenuated relative to the preliminary outgoing LIDAR signal received by the amplifier 314, or that has zero, insubstantial or negligible power. The LIDAR output signal output from the LIDAR chip can each include or consist of light from an outgoing LIDAR signal that is amplified relative to the outgoing LIDAR signal received by an amplifier 314. Any inactive LIDAR output signals output from the LIDAR chip can each include or consist of light from an outgoing LIDAR signal that is not amplified relative to the outgoing LIDAR signal received by an amplifier 314, that is not substantially amplified relative to the outgoing LIDAR signal received by an amplifier 314, or that has an attenuated power level relative to the power level of the outgoing LIDAR signal received by an amplifier 314.

The selector controller 76 can operate the amplifiers 314 so as to select which amplifiers 314 serve as an active amplifier and which amplifiers 314 serve as an inactive amplifier. For instance, the selector controller 76 can operate one or more amplifiers 314 so as to substantially amplify the power of the system output signals to the desired levels. Additionally, the selector controller 76 can concurrently operate one or more amplifiers 314 so to not amplify, or not substantially amplify, the power of the light included in the outgoing LIDAR signal received by each of the one or more amplifiers. Amplifiers that substantially amplify the power of the light included in the system output signal output from the amplifier serve as the active amplifiers. The amplifiers that do not amplify, or do not substantially amplify, the power of the light included in the outgoing LIDAR signal received by each of the one or more amplifiers serve as the inactive amplifiers. One example of a suitable amplifier includes Semiconductor Optical Amplifiers (SOAs). Semiconductor Optical Amplifiers (SOAs) include a semiconductor gain medium to which a forward electrical bias so as to amplify the power of the light in the outgoing LIDAR signal received by the SOA. These amplifiers can be operated as active amplifiers by applying an electrical bias above a threshold voltage in the direction needed to provide amplification. Semiconductor Optical Amplifiers (SOAs) can also be operated as inactive amplifiers by not applying an electrical bias to the amplifier, by applying the electrical bias below the threshold voltage in the direction needed to provide amplification, by applying a reverse electrical bias to the amplifier so as to attenuate the power of the light in the system output signal, or by applying the electrical bias in the direction opposite from the direction needed to provide amplification. Application of the electrical bias in the direction opposite from the direction needed to provide amplification can provide attenuation of the system output signal. For instance, a forward bias above a voltage threshold is often applied to Semiconductor Optical Amplifiers (SOAs) in order to achieve amplification while application of a reverse bias can provide attenuation. Accordingly, the inactive amplifiers can output a system output signal with a power level that is the same as, substantially the same as, or below the power of the preliminary outgoing LIDAR signal received by the amplifier.

The operation of the amplifiers 314 selects which of the outgoing LIDAR signals carries the light that is included in the LIDAR output signal output from the LIDAR chip and accordingly in the system output signal output from the LIDAR system. For instance, an outgoing LIDAR signal output from the active amplifier can be the source of the light included in the LIDAR output signal output from the LIDAR chip and accordingly in the system output signal output from the LIDAR system. In some instances, all or a portion of the amplifiers 314 can have a length such that when the selector controller 76 operates an amplifier as an inactive amplifier, an outgoing LIDAR signal is not output from the amplifier or an inactive outgoing LIDAR output signal is output from the amplifier with a power level that is insubstantial relative to the power level of the LIDAR output signal output from the LIDAR chip. In the event that one or more of the inactive amplifiers outputs an outgoing LIDAR signal with a power level that is negligible or insubstantial relative to the power of the active outgoing LIDAR signal, the signal output from the inactive amplifier can serve as an inactive outgoing LIDAR signal. Accordingly, inactive amplifiers can output an inactive outgoing LIDAR signal or no outgoing LIDAR signal at all. While the electronics use light from any active outgoing LIDAR signals to generate LIDAR data, the electronics do not use light from inactive outgoing LIDAR signal to generate LIDAR data.

In some instances, the selector controller 76 operates the amplifiers 314 such that a ratio of the power of the outgoing LIDAR signal output from an active amplifier: the power of any inactive outgoing LIDAR signal output from an inactive amplifier is greater than 10,000:1, 1000:1 or 100:1 for each of the inactive amplifiers and can be infinitely high when an inactive amplifier 314 outputs an outgoing LIDAR signal with a zero power level or does not output an outgoing LIDAR signal. Additionally, or alternately, in some instances, the selector controller 76 can operate all or a portion of the active amplifiers 314 such that a power level of the outgoing LIDAR signal output from the active amplifier is more than 10, 50, or 100 times the power level of the outgoing LIDAR signal received by the active amplifier. Additionally, or alternately, in some instances, the selector controller 76 can operate all or a portion of the inactive amplifiers 314 such that a power level of the outgoing LIDAR signal received by the inactive amplifier is more than 10, 100, or 1000 times a power level of the inactive outgoing LIDAR signal output from the inactive amplifier.

The selector controller 76 operates the amplifiers 314 so as to alternate the active amplifier between amplifiers associated with different channel indices. For instance, the amplifiers frequency versus time patterns for the LIDAR output signals shown in FIG. 4D can be generated by operating the amplifiers such that the amplifier associated with channel index m=1 can be alternated with the amplifier associated with channel index m=2. The amplifier associated with channel index m=1 can be turned off for all or a portion of the time that amplifier associated with channel index m=2 amplifies the outgoing LIDAR signal associated with channel index m=2 and the amplifier associated with channel index m=2 can be turned off for all or a portion of the time that amplifier associated with channel index m=1 amplifies the outgoing LIDAR signal associated with channel index m=1. This allows the active amplifier to amplify the active system output signal to the desired power level while energy is conserved by turning off any inactive amplifiers.

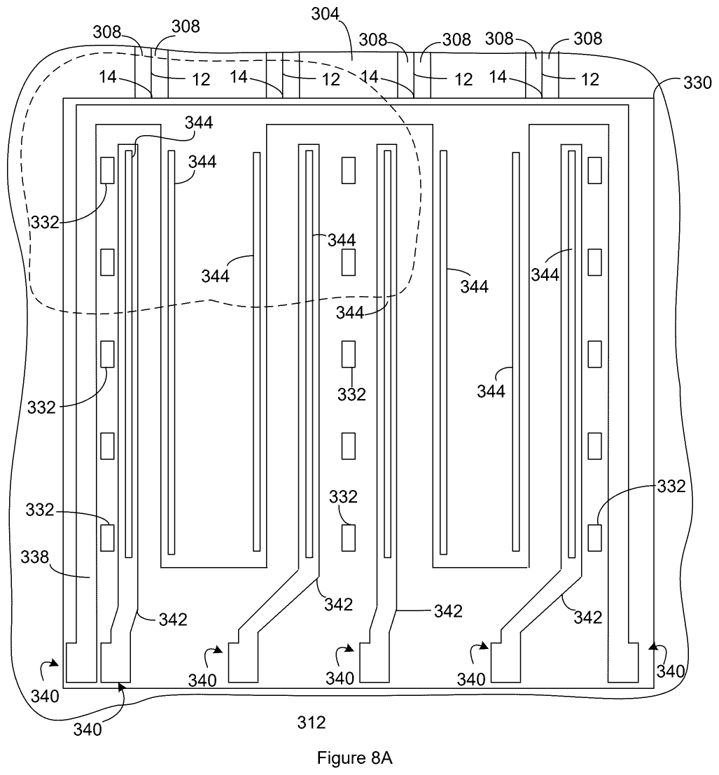

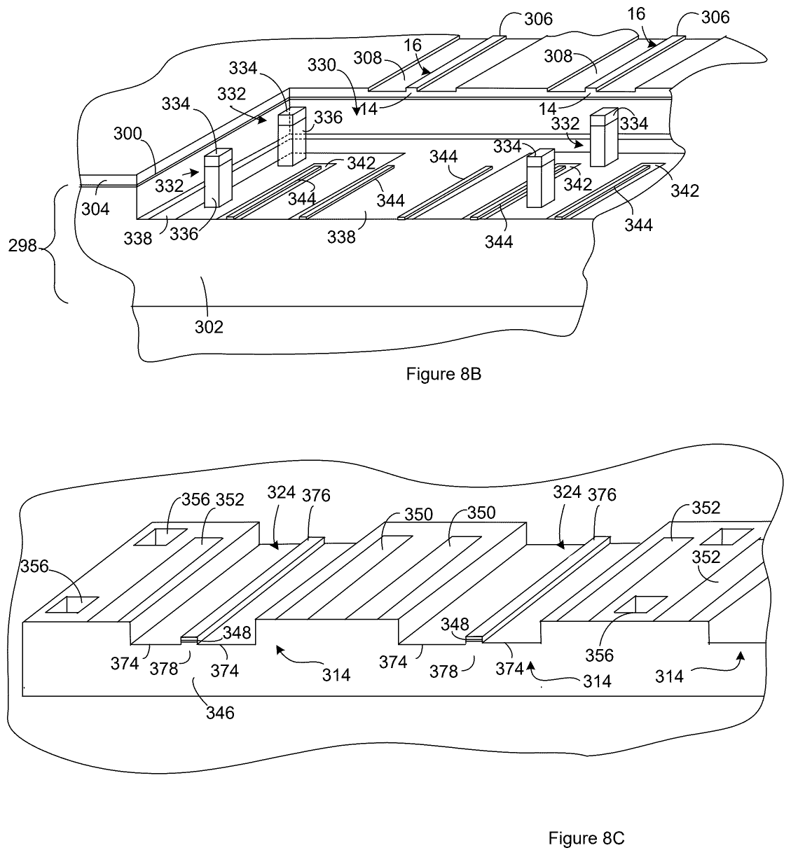

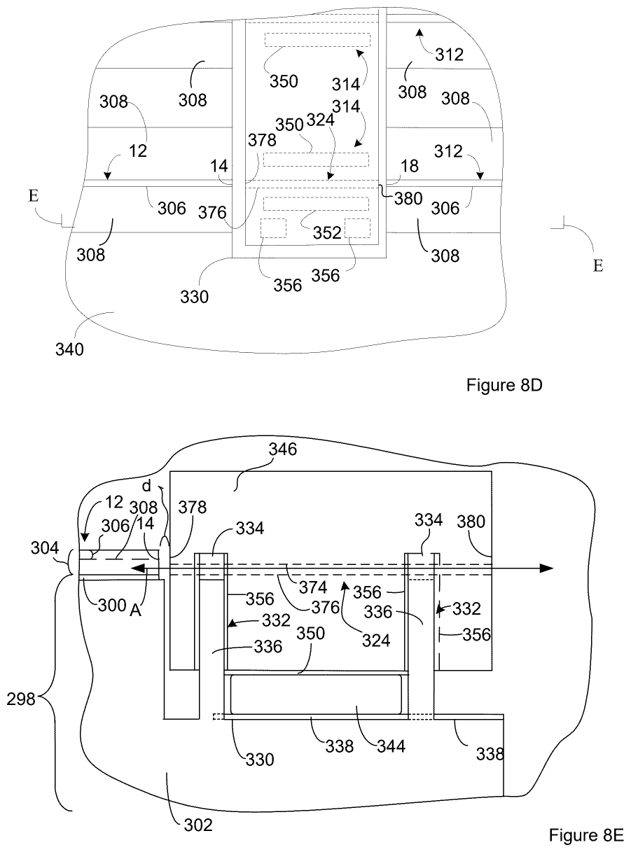

FIG. 8A through FIG. 8E illustrate an example of an interface between an amplifier chip and a LIDAR chip. FIG. 8A is a topview of a portion of a LIDAR chip that includes an interface for optically coupling the LIDAR chip with an amplifier chip. FIG. 8B is a perspective view of the portion of a LIDAR chip shown by the dashed lines in FIG. 8A labeled B. The LIDAR chip includes a stop recess 330 sized to receive the amplifier chip. The stop recess 330 extends through the light-transmitting medium 304 and into the base 298. In the illustrated version, the stop recess 330 extends through the light-transmitting medium 304, the buried layer 300, and into the substrate 302.

The facets 14 of the utility waveguides 12 are included in the lateral sides of the stop recess 330. Although not shown, the facets 14 of the utility waveguides 12 can include an anti-reflective coating. A suitable anti-reflective coating includes, but is not limited to, single-layer coatings such as silicon nitride or aluminum oxide, or multi-layer coatings, which may contain silicon nitride, aluminum oxide, and/or silica.

One or more stops 332 extend upward from the bottom of the stop recess 330. For instance, FIG. 8B illustrates four stops 332 extending upward from the bottom of the stop recess 330. The stops 332 include a cladding 334 positioned on a base portion 336. The substrate 302 can serve as the base portion 336 of the stops 332 and the stop 332 can exclude the buried layer 300. The portion of the substrate 302 included in the stops 332 can extend from the bottom of the stop recess 330 up to the level of the buried layer 300. For instance, the stops 332 can be formed by etching through the buried layer 300 and using the underlying substrate 302 as an etch-stop. As a result, the location of the top of the base portion 336 relative to the optical mode of a light signal in a utility waveguide 12 is well known because the buried layer 300 defines the bottom of the second waveguide and the top of the base portion 336 is located immediately below the buried layer 300. The cladding 334 can be formed on base portion 336 of the stops 332 so as to provide the stops 332 with a height that will provide the desired vertical alignment between each amplifier waveguide on an amplifier chip and one of the utility waveguides 12.

A first electrical conductor 338 extends across a bottom of the stop recess 330. The first electrical conductor 338 can include a contact pad 340 that can be used to provide electrical communication between the electronics and the first electrical conductor 338. Second electrical conductors 342 each extend from across the bottom of the stop recess 330. Each of the second electrical conductors 342 can include a contact pad 340 that can be used to provide electrical communication between the electronics and the second electrical conductor 342. Solder 344 is positioned on the first electrical conductor 338 and the second electrical conductor 342.

FIG. 8C is a perspective view of one embodiment of an amplifier chip. The illustrated amplifier chip is within the class of devices known as planar optical devices. The amplifier chip includes an amplifier waveguide 324 defined in a gain medium 346. Suitable gain media include, but are not limited to, InP, InGaAsP, and GaAs.

Trenches 374 extending into the gain medium 346 define a ridge 376 in the gain medium 346. The ridge 376 defines an amplifier waveguide 324 that can serve as a selector waveguide 20 disclosed in the context of at least FIG. 1 and FIG. 1B. In some instances, the gain medium 346 includes one or more layers 348 in the ridge and/or extending across the ridge 376. The one or more layers 348 can be positioned between different regions of the gain medium 346. The region of the gain medium 346 above the one or more layers 348 can be the same as or different from the region of the gain medium 346 below the one or more layers 348. The layers can be selected to constrain light signals guided through the amplifier waveguide 324 to a particular location relative to the ridge 376. Each of the layers 348 can have a different composition of a material that includes or consists of two or more components selected from a group consisting of In, P, Ga, and As. In one example, the gain medium 346 is InP and the one or more layers 348 each includes Ga and As in different ratios.

The amplifier waveguide 324 provides an optical pathway between a first facet 378 and a second facet 380 that can serve as the port 18. Although not shown, the first facet 378 and/or the second facet 380 can optionally include an anti-reflective coating. A suitable anti-reflective coating includes, but is not limited to, single-layer coatings such as silicon nitride or aluminum oxide, or multi-layer coatings that may contain silicon nitride, aluminum oxide, and/or silica.

The amplifier chip includes first amplifier electrical conductors 350 and second amplifier electrical conductors 352. The first amplifier electrical conductors 350 are arranged on the amplifier chip such that the amplifier chip can be inverted and placed in the stop recess 330 with each of the first amplifier electrical conductors 350 aligned with a portion of the first electrical conductor 338 such that solder 344 is positioned between the first amplifier electrical conductors 350 and the first electrical conductor 338 with the solder contacting the first amplifier electrical conductors 350 and the first electrical conductor 338. The second amplifier electrical conductors 352 are arranged on the amplifier chip such that the amplifier chip can be inverted and placed in the stop recess 330 with each of the second amplifier electrical conductors 352 aligned with one of the second electrical conductors 340 such that solder 344 is positioned between the second amplifier electrical conductors 352 and the second electrical conductor 340 and the solder 344 contacts the second amplifier electrical conductors 352 and the second electrical conductor 340.

The amplifier chip also includes one or more alignment recesses 356. Each of the alignment recesses 356 is sized to receive one of the stops 332.

FIG. 8D and FIG. 8E illustrate a LIDAR system that includes the LIDAR chip of FIG. 8A and FIG. 8B interfaced with the amplifier chip of FIG. 8C. The LIDAR chip is inverted and positioned in the stop recess 330. FIG. 8D is a topview of the LIDAR system. FIG. 8E is a sideview of a cross section of the system taken through a utility waveguide 12 on the LIDAR chip and the amplifier waveguide 324 on the amplifier chip. For instance, the cross section of FIG. 8E can be taken a long a line extending through the brackets labeled E in FIG. 8D. FIG. 8D and FIG. 8E each includes dashed lines that illustrate features that are located behind other features in the system. For instance, FIG. 8D includes dashed lines the show the locations of the ridge 376 of the amplifier waveguide 324, the first amplifier electrical conductors 350, the second amplifier electrical conductors 352 and the alignment recesses 356 under the gain medium 346. Additionally, FIG. 8E includes dashed lines that illustrate the locations of the amplifier waveguide 324 behind the stops 332. FIG. 8E also includes dashed lines that illustrate the location where the ridge 86 of the utility waveguide 12 interfaces with the slab regions 308 that define the utility waveguide 12 and dashed lines that illustrate the location where the ridge 376 of the amplifier waveguide 324 interfaces with slab regions 374 of the amplifier chip.

The amplifier chip is positioned in the stop recess 330 on the LIDAR chip. The amplifier chip is positioned such that the ridge 376 of the amplifier waveguide 324 is located between the bottom of the amplifier chip and the base 298 of the LIDAR chip. Accordingly, the amplifier chip is inverted in the stop recess 330. Solder 344 or other electrically conducting adhesive contacts each of the first amplifier electrical conductors 350 and the first electrical conductor 338. Although not shown in FIG. 4E, the solder 344 or other electrically conducting adhesive contacts are arranged such that the solder 344 or other electrically conducting adhesive contacts each of the second amplifier electrical conductors 352 and one of the second electrical conductor 340. The solder 344 or other adhesive 358 can immobilize the amplifier chip relative to the LIDAR chip.

The facet 14 of the utility waveguide 12 is aligned with the first facet 378 of the amplifier waveguide 324 such that the utility waveguide 12 and the amplifier waveguide 324 can exchange light signals. As shown by the line labeled A, the system provides a horizontal optical path in that the direction that light signals travel from the utility waveguide 12 and through the amplifier chip before exiting the LIDAR chip through the second facet 380. A top of the first facet 378 of the amplifier waveguide 324 is at a level that is below the top of the facet 14 of the utility waveguide 12.

The one or more stops 332 on the LIDAR chip are each received within one of the alignment recesses 356 on the amplifier chip. The top of each stop 332 contacts the bottom of the alignment recess 356. As a result, the interaction between stops 332 and the bottom of the alignment recesses 356 prevents additional movement of the amplifier chip toward the LIDAR chip. In some instances, the amplifier chip rests on top of the stops 332.

As is evident from FIG. 8E, the first facet 378 of the amplifier waveguide 324 is vertically aligned with the facet 14 of the utility waveguide 12. As is evident from FIG. 8D, the first facet 378 of the amplifier waveguide 324 can also be horizontally aligned with the facet 14 of the utility waveguide 12. The horizontal alignment can be achieved by alignment of marks and/or features on the amplifier chip and the LIDAR chip.

The vertical alignment can be achieved by controlling the height of the stops 332 on the LIDAR chip. For instance, the cladding 334 on the base portion 336 of the stops 332 can be grown to the height that places the first facet 378 of the amplifier waveguide 324 at a particular height relative to the facet 14 of the utility waveguide 12. The desired cladding 334 thickness can be accurately achieved by using deposition techniques such as evaporation, plasma enhanced chemical vapor deposition (PECVD), and/or sputtering to deposit the one or more cladding layers. As a result, one or more cladding layers can be deposited on the base portion 336 of the stops 332 so as to form the stops 332 to a height that provides the desired vertical alignment. Suitable materials for layers of the cladding 334 include, but are not limited to, silica, silicon nitride, and polymers.

In FIG. 8E, the first facet 378 is spaced apart from the facet 14 by a distance labeled d. The distance “d” can be less than 5 μm, 3 μm, or 1 μm and/or greater than 0.0 μm. In FIG. 8E, the atmosphere in which the LIDAR chip is positioned is located in the gap between the first facet 378 and facet 14; however, other gap materials can be positioned in these gaps. For instance, a solid gap material can be positioned in the gap. Examples of suitable gap materials include, but are not limited to, epoxies and polymers.

FIG. 8E shows the solder 344 in contact with the first amplifier electrical conductor 350 and the first electrical conductor 338. As a result, the first amplifier electrical conductor 350, the solder 344, and the first electrical conductor 338 can provide electrical communication between a contact pad 340 on the first electrical conductor 338 and the amplifier. Although not illustrated, the second amplifier electrical conductor 352, the solder 344, and the second electrical conductor 342 can provide electrical communication between the contact pad 340 on the second electrical conductor 342 and an amplifier on the amplifier chip. Accordingly, the electronics can independently operate each of the amplifiers on the amplifier chip by applying a bias between contact pad 340 on the first electrical conductor 338 and the contact pad 340 on the second electrical conductor 342 that is associated with the amplifier. The bias can be applied so as to drive an electrical current through the gain medium in the amplifier. During concurrent operation of multiple different amplifiers, the first electrical conductor 338 can act as a common conductor.

As is evident from FIG. 1, the LIDAR system can optionally include one or more light signal amplifiers 446 in addition to the amplifiers 314. For instance, an amplifier 446 can optionally be positioned along a utility waveguide 12 as illustrated in the light source 10 of FIG. 5. The electronics can operate the amplifier 446 so as to amplify the power of the outgoing LIDAR signal and accordingly of the resulting system output signal. As another example, an amplifier 446 can optionally be positioned along the detector output lines 154 as illustrated in FIG. 4B. Suitable amplifiers 446 for use on the LIDAR chip, include, but are not limited to, Semiconductor Optical Amplifiers (SOAs) and SOA arrays.

Light sensors that are interfaced with waveguides on a LIDAR chip can be a component that is separate from the chip and then attached to the chip. For instance, the light sensor can be a photodiode, or an avalanche photodiode. Examples of suitable light sensors include, but are not limited to, InGaAs PIN photodiodes manufactured by Hamamatsu located in Hamamatsu City, Japan, or an InGaAs APD (Avalanche Photo Diode) manufactured by Hamamatsu located in Hamamatsu City, Japan. These light sensors can be centrally located on the LIDAR chip. Alternately, all or a portion the waveguides that terminate at a light sensor can terminate at a facet located at an edge of the chip and the light sensor can be attached to the edge of the chip over the facet such that the light sensor receives light that passes through the facet. The use of light sensors that are a separate component from the chip is suitable for all or a portion of the light sensors selected from the group consisting of the first light sensor and the second light sensor.

As an alternative to a light sensor that is a separate component, all or a portion of the light sensors can be integrated with the chip. For instance, examples of light sensors that are interfaced with ridge waveguides on a chip constructed from a silicon-on-insulator wafer can be found in Optics Express Vol. 15, No. 21, 13965-13971 (2007); U.S. Pat. No. 8,093,080, issued on Jan. 10 2012; U.S. Pat. No. 8,242,432, issued Aug. 14 2012; and U.S. Pat. No. 6,108,8472, issued on Aug. 22, 2000 each of which is incorporated herein in its entirety. The use of light sensors that are integrated with the chip are suitable for all or a portion of the light sensors selected from the group consisting of the first light sensor and the second light sensor.

Suitable electronics 56 can include, but are not limited to, a controller that includes or consists of analog electrical circuits, digital electrical circuits, processors, microprocessors, digital signal processors (DSPs), Field Programmable Gate Arrays (FPGAs), computers, microcomputers, or combinations suitable for performing the operation, monitoring and control functions described above. In some instances, the controller has access to a memory that includes instructions to be executed by the controller during performance of the operation, control and monitoring functions. In some instances, the functions of a LIDAR data generator and the peak finder can be executed by Field Programmable Gate Arrays (FPGAs), digital signal processors (DSPs), Application Specific Integrated Circuits, firmware, software, hardware, and combinations thereof. Although the electronics are illustrated as a single component in a single location, the electronics can include multiple different components that are independent of one another and/or placed in different locations. Additionally, as noted above, all or a portion of the disclosed electronics can be included on the chip including electronics that are integrated with the chip.

An example of a suitable selector controller 76 executes the attributed functions using firmware, hardware, or software or a combination thereof. An example of a suitable light source controller 62 executes the attributed functions using firmware, hardware, or software or a combination thereof. An example of a suitable data processor 155 executes the attributed functions using firmware, hardware, or software or a combination thereof. An example of a suitable steering controller 60 executes the attributed functions using firmware, hardware, or software or a combination thereof.

Components on the LIDAR chip can be fully or partially integrated with the LIDAR chip. For instance, the integrated optical components can include or consist of a portion of the wafer from which the LIDAR chip is fabricated. A wafer that can serve as a platform for a LIDAR chip can include multiple layers of material. At least a portion of the different layers can be different materials. As an example, in a silicon-on-insulator wafer that includes the buried layer 300 between the substrate 302 and the light-transmitting medium 304 as shown in FIG. 6, the integrated on-chip components can be formed by using etching and masking techniques to define the features of the component in the light-transmitting medium 304. For instance, the slab regions 308 that define the waveguides and the stop recess can be formed in the desired regions of the wafer using different etches of the wafer. As a result, the LIDAR chip includes a portion of the wafer and the integrated on-chip components can each include or consist of a portion of the wafer. Further, the integrated on-chip components can be configured such that light signals traveling through the component travel through one or more of the layers that were originally included in the wafer. For instance, the waveguide of FIG. 6 guides light signal through the light-transmitting medium 304 from the wafer. The integrated components can optionally include materials in addition to the materials that were present on the wafer. For instance, the integrated components can include reflective materials and/or a cladding.

Numeric labels such as first, second, third, etc. are used to distinguish different features and components and do not indicate sequence or existence of lower numbered features. For instance, a second component can exist without the presence of a first component and/or a third step can be performed before a first step. The light signals disclosed above each include, consist of, or consist essentially of light from the prior light signal(s) from which the light signal is derived. For instance, an incoming LIDAR signal includes, consists of, or consists essentially of light from the LIDAR input signal.

Although the LIDAR system is disclosed as real signals such as the complex data signal, the LIDAR system can also use complex signals. As a result, the mathematical transform can be a complex transform and the component associated with the generation and use of a complex data signal having an in-phase component and a quadrature component can be added to the LIDAR system. As a result, the LIDAR system can use a multiple signal combiners and multiple ADCs. Additionally, or alternately, a single light sensor can replace each of the balanced detectors.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

1. A system, comprising:
a LIDAR system having a signal selector configured to receive multiple outgoing LIDAR signals that each carries a different wavelength channel;
the LIDAR system including a selector controller configured to operate the signal selector such that the signal selector serially outputs multiple different selections of the outgoing LIDAR signals,
each selection of the system output signals includes multiple different outgoing LIDAR signals that are concurrently output by the signal selector; and
the LIDAR system being configured to concurrently transmit multiple system output signals that each includes light from a different one of the outgoing LIDAR signals that has been output from the signal selector.

2. The system of claim 1, wherein the LIDAR system is configured to transmit the system output signals such that the system output signals in each selection of the system output signals each has a spot size that overlaps the spot size of one or more of the system output signals in the selection of the system output signals.

3. The system of claim 1, wherein the selector controller is configured to operate the signal selector such that the signal selector concurrently outputs a portion of the outgoing LIDAR signals received by the signal selector but does not output a second portion of the outgoing LIDAR signals received by the signal selector.

4. The system of claim 3, wherein the selector controller includes multiple Semiconductor Optical Amplifiers (SOAs).

5. The system of claim 1, wherein the LIDAR system includes a light source that includes multiple laser sources and each of the outgoing LIDAR signals includes light from a different one of the laser sources.

6. The system of claim 5, wherein the LIDAR system includes a light source controller that operates the light sources such that each of the outgoing LIDAR signals has a frequency versus time pattern that repeats in cycles, each of the cycles including chirp periods where the frequency of the outgoing LIDAR signal is chirped at a constant rate.

7. The system of claim 6, wherein the light source controller that operates the light sources such that the frequency versus time patterns of the outgoing LIDAR signals are out of phase with one another.

8. The system of claim 6, wherein each of the cycles has the same duration and each frequency versus time patterns is out of phase with at least one of the frequency versus time patterns by the duration of the cycles divided by the number of wavelength channels.

9. The system of claim 6, wherein each of the cycles has the same duration and each of the frequency versus time patterns is out of phase with two of the frequency versus time patterns by the duration of the cycles divided by the number of wavelength channels.

10. The system of claim 1, wherein the LIDAR system includes a multiplexer configured to receive the outgoing LIDAR signals from the signal selector and to multiplex the receive the received outgoing LIDAR signals onto a common waveguide.

11. A system, comprising:
a LIDAR system having a signal selector configured to receive an outgoing LIDAR signal having a frequency versus time pattern that repeats in cycles, each of the cycles including a chirp period where the frequency of the outgoing LIDAR signal is chirped at a constant rate,
the chirp period including a reference window in series with a transmission window,
a portion of the outgoing LIDAR signal during the transmission window of the chirp period being a chirp segment of the outgoing LIDAR signal and a portion of the outgoing LIDAR signal during the reference window of the chirp period being a reference segment of the outgoing LIDAR signal;
the LIDAR system including a selector controller configured to operate the signal selector such that the signal selector outputs the portion of the outgoing LIDAR signal that includes light from the transmission segment of the outgoing LIDAR signal but such that the signal selector does not output the portion of the outgoing LIDAR signal that includes light from the reference segment of the outgoing LIDAR signal;
the LIDAR system configured to output a system output signal that includes light from the outgoing LIDAR signal that was output from the signal selector;
the LIDAR system being configured to receive a system return signal that includes light from the system output signal after being reflected by an object located outside of the LIDAR system;
the LIDAR system including a light combiner that receives the light from a reference signal and light from the system return signal,
the reference signal received by the light combiner including light from the transmission segment of the outgoing LIDAR signal and also including light from the reference segment of the outgoing LIDAR signal.
the light combiner configured to combine light from the system return signal with light from reference signal so as to generate a composite signal beating at a beat frequency.

12. The system of claim 11, wherein the LIDAR system includes a splitter that receives a preliminary outgoing LIDAR signal and outputs the reference signal and the outgoing LIDAR signal.

13. The system of claim 1, wherein the system output signal is a first one of multiple system output signals and the LIDAR system is configured to concurrently output.

14. The system of claim 13, wherein the LIDAR system is configured to output multiple of the system output signals such that each of the system output signals are concurrently directed to a sample region and the system output signals each have a spot size that overlaps in the sample region.
